(19) United States
(12) Patent Application Publication
(10) Pub. No.: US 2013/0225127 A1
(43) Pub. Date: Aug. 29, 2013

(54) PROXIMITY TAG

(71) Applicants: John Cavacuiti, North Vancouver (CA); Kelly Fenning, Burnaby (CA); Gerald Gutierrez, Burnaby (CA)

(72) Inventors: John Cavacuiti, North Vancouver (CA); Kelly Fenning, Burnaby (CA); Gerald Gutierrez, Burnaby (CA)

(73) Assignee: ACCO Brands Corporation, Lincolnshire, IL (US)

(21) Appl. No.: 13/571,186

(22) Filed: Aug. 9, 2012

Related U.S. Application Data
(60) Provisional application No. 61/521,660, filed on Aug. 9, 2011.

(51) Int. Cl. H04W 12/02

(52) U.S. Cl. CPC H04W 12/02
USPC 455/411

(57) ABSTRACT

A system and method for securing a portable consumer device is disclosed. One embodiment of the present invention may be directed to a security system comprising a first wireless apparatus for use with a mobile communication device and a second wireless apparatus configured to removably and electrically couple to the mobile communication device. The second wireless apparatus comprising a second processor, a mobile communication device interface element, and a second computer readable medium coupled to the second processor and comprising code executable by the second processor to implement a method comprising determining whether the second wireless apparatus is within a particular distance from the first wireless apparatus, and locking the mobile communication device from use if the second wireless apparatus is not within the particular distance from the first wireless apparatus. Some embodiments may lock the mobile communication device from use if a tamper switch has been triggered.

### CROSS-REFERENCES TO RELATED APPLICATIONS

This application is related to U.S. Provisional Application No. 61/521,660, filed on Aug. 9, 2011, titled, “Proximity Tag,” by Cavacuiti, et al., the entire contents of which is incorporated herein in its entirety.

### BACKGROUND

Mobile devices have become more common in modern day society, and as technology advances, portable mobile devices have become smaller in size but more powerful in processing power and memory storage. A personal mobile device may contain a significant amount of personal data of a user, such as contact information, payment information, and photos. Thus, it has become important to secure personal mobile devices from loss or theft.

Embodiments of the invention described in this document relate to physical security and loss prevention of mobile electronic communication devices such as mobile phones, tablet computers and portable computers. The proliferation of mobile electronics has increased the rates of theft and accidental loss. The increasing performance and versatility of such products have also increased the immediate and consequential costs of such losses in the form of replacement and potential breach of privacy.

Embodiments of the invention address these and other problems.

### BRIEF SUMMARY

Embodiments of the invention relate to a security system consisting of a pair of wireless apparatuses that communicate with each other continually. One (first) wireless apparatus is carried by the user of a mobile device to be protected or secured. The other (second) wireless apparatus is attached to the mobile device. The first and second wireless apparatuses are in continual communication. The security system may issue alert commands to the first and second wireless apparatuses and issue locking commands to the protected device when the second wireless apparatus and first wireless apparatus are out of range or if the second wireless apparatus has been detached (or attempted to be detached) from the mobile device without authorization. The user may configure settings and modes through a software interface, such as an application, that may be downloaded onto the mobile device in order to maximize the utility of the system for their needs.

A first transceiver may be in the form of a first wireless apparatus (e.g., key) fob, card, or some other small pocket-sized device that can be carried by the user on an everyday basis at all times. A second transceiver may be a case, dongle, or other device that can be securely attached and coupled to a mobile device (e.g. mobile communication device). Examples of mobile devices to be protected or secured include, but are not limited to, mobile phones or smartphones (e.g., iPhone™, Android™), digital music players (e.g., iPod™), tablets (e.g., iPad™), and electronic readers (e.g., Kindle™). These mobile devices can be easily misplaced or stolen.

Embodiments of the invention relate to a security system that is capable of determining whether a user carrying a first wireless apparatus and a protected mobile device attached to a second wireless apparatus are within range from each other. If the second wireless apparatus containing the mobile device is not within range of the first wireless apparatus carried by the user, the mobile device may be in the process of being stolen from the user. The first wireless apparatus may alert the user that the second transceiver is no longer within range, indicating potential theft of the mobile device. Additionally, the second transceiver, in communication with the first transceiver, may lock the mobile device if the second transceiver determines that it is no longer within range from the first transceiver for a predetermined period of time. Locking the mobile device prevents tampering of the mobile device by someone other than the user. The system may comprise an application that may be downloaded to a mobile device and executed on the mobile device's operating system to manage the security apparatus according to embodiments of the invention. The user may use the application to configure and update settings and modes for the first wireless apparatus and/or the second wireless apparatus including the transmission range of the first and second wireless apparatus (i.e. the distance the first and second wireless apparatus may be apart before an alarm or locking command is issued).

One embodiment of the present invention may be directed to a security system comprising a first wireless apparatus for use with a mobile communication device and a second wireless apparatus. The first wireless apparatus comprising a first processor, a first antenna, and a first transceiver device electrically coupled to the first antenna and the first processor. The second wireless apparatus comprising a second processor, a second antenna, a second transceiver electrically coupled to the second antenna, a mobile communication device interface element and a second computer readable medium coupled to the second processor and comprising code executable by the second processor to implement a first method. The first method comprising sending a wireless signal request to the first wireless apparatus, determining whether the second wireless apparatus is within a particular distance from the first wireless apparatus, and locking the mobile communication device from use if the second wireless apparatus is not within the particular distance from the first wireless apparatus. The second wireless apparatus may further be configured to removably and electrically couple to the mobile communication device through the mobile communication device interface element. The mobile communication device may comprise a third processor and a third computer readable medium coupled to the third processor and comprising code executable by the third processor to implement a second method. The second method comprising receiving a data input from a user and updating the second wireless apparatus with information corresponding to the data input.

Another embodiment of the present invention is directed to a method comprising sending a wireless signal request to a first wireless apparatus in communication with a second wireless apparatus configured to removably and electrically couple to a mobile communication device of a user, determining whether the first wireless apparatus is within a particular distance from the second wireless apparatus, and locking the mobile communication device if the first wireless apparatus is not within the particular distance of the second wireless apparatus.

Another embodiment of the present invention is directed to a method comprising sending a wireless signal request to a second wireless apparatus, wherein the second wireless apparatus is configured to removably and electrically couple to a mobile communication device of a user, determining whether the second wireless apparatus is within a particular distance from the first wireless apparatus, and alerting the user if the second wireless apparatus is not within the particular distance of the first wireless apparatus, wherein the second wireless apparatus sends a lock command to the mobile communication device if the first wireless apparatus is not within the particular distance of the second wireless apparatus.

Another embodiment of the present invention is directed to a security system comprising a first wireless apparatus comprising a first processor, a first antenna, a first housing, and a first transceiver electrically coupled to the first antenna and the first processor and a second wireless apparatus comprising a second processor, a second antenna, a second transceiver electrically coupled to the second antenna, a second housing, a tamper switch physically coupled to the second housing and electrically coupled to the second processor, a mobile communication device interface element, and a second computer readable medium coupled to the second processor and comprising code executable by the second processor to implement a first method comprising determining if the tamper switch is triggered and locking the mobile communication device from use if the tamper switch is triggered, wherein the second wireless apparatus is configured to removably and electrically couple to a mobile communication device through the mobile communication device interface element.

Another embodiment of the present invention is directed to a method comprising receiving a wireless signal request from a first wireless apparatus at a second wireless apparatus, wherein the second wireless apparatus is configured to removably and electrically couple to a mobile communication device of a user, and wherein the second wireless apparatus comprises a tamper switch, determining if the tamper switch on the second wireless apparatus is triggered, and locking the mobile communication device from use if the tamper switch is triggered.

These and other embodiments are described in further detail below.

### BRIEF DESCRIPTION OF THE DRAWINGS

FIG. 1 shows a block diagram illustrating a security system according to embodiments of the invention.

FIG. 2 shows another exemplary block diagram illustrating a security system according to embodiments of the invention.

FIG. 3 shows a perspective view of a security system including exemplary embodiments of a first wireless apparatus, a second wireless apparatus, and a mobile communication device according to an embodiment of the invention.

FIGS. 4A and 4B show perspective views of an exemplary first wireless apparatus according to an embodiment of the invention.

FIG. 5 shows an exemplary first wireless apparatus and button function chart according to an embodiment of the invention.

FIG. 6 shows perspective views of an exemplary first wireless apparatus according to an embodiment of the invention.

FIG. 7 shows a perspective view of the front of an exemplary second wireless apparatus according to an embodiment of the invention.

FIG. 8 shows a perspective view of the back of an exemplary second wireless apparatus according to an embodiment of the invention.

FIGS. 9A and 9B show perspective views of an exemplary second wireless apparatus according to an embodiment of the invention.

FIGS. 10A and 10B show perspective views of various stages of attachment of an exemplary second wireless apparatus and an exemplary mobile communication device according to an embodiment of the invention.

FIGS. 11A and 11B show perspective views of various stages of attachment of an exemplary second wireless apparatus and an exemplary mobile communication device according to an embodiment of the invention.

FIG. 12 shows a flowchart illustrating a method according to embodiments of the invention.

FIG. 13 shows a hardware state diagram illustrating a method according to embodiments of the invention.

FIG. 14 shows a user state diagram illustrating a method according to embodiments of the invention.

FIG. 15 shows an exemplary screenshot of using an application and launching said application according to an embodiment of the invention.

FIGS. 16-22 show exemplary screenshots of using an application to operate a method and system according to embodiments of the invention.

FIG. 23 shows an exemplary screenshot of using an application to configure settings for a system according to embodiments of the invention.

FIG. 24 shows a block diagram of an exemplary computer system.

### DETAILED DESCRIPTION

Embodiments of the present invention relate to a security solution for portable devices including a second wireless apparatus that is attached to the portable device and a first wireless apparatus that is portable and is carried by a user (e.g. attached to a keychain, fits in a user's pocket, and/or attaches to a user's clothes). The two wireless apparatuses communicate over a short-range wireless link. When the communication link is broken due to the two wireless apparatuses moving out of range of each other, a warning condition is entered, resulting in various effects including alerting the user that the wireless apparatuses are out of range. If the wireless apparatus remains out of range for a predetermined period of time, an alarm condition may be entered and a command may be issued to lock the mobile communications device from use. Additionally, an alarm condition may be entered if the second wireless apparatus determines that the mobile communication device is being tampered with while in an armed mode. The second wireless apparatus may immediately lock the mobile communication device if the second wireless apparatus determines the mobile communication device is being tampered with.

Embodiments of the present invention provide a number of technical advantages. The security system provides a simple, efficient, interactive, customizable, and effective solution to securing valuable mobile devices. The system allows a consumer to rest assured that their mobile device is within a safe distance of them at all times and that the user will be reminded if they have left their mobile device behind or will be alerted if a third party tries to steal their mobile device. Additionally, the user may be alerted if an unauthorized party attempts to tamper with the security system in order to overcome its security functionality. Furthermore, if the mobile device is taken, the user's sensitive financial and personal information is protected because the mobile device automatically locks the mobile device from use. This is particularly advantageous as consumers use their mobile devices for a wide variety of secure or sensitive applications including performing financial transactions, interacting with peers, performing business transactions, communicating with business contacts, and storing sensitive information about themselves and their family (e.g. pictures, passwords, social security numbers, etc.).

Prior to discussing particular embodiments of the technology, a further description of some terms can include provided for a better understanding of embodiments of the technology.

A “first wireless apparatus” can include any electronic device that includes a means for communicating with a second wireless apparatus. The first wireless apparatus may be an independent device or may be a sub-component or portion of another device. Additionally, the first wireless apparatus may comprise any means for communicating with the second wireless apparatus including a transmitter, receiver, transceiver, separate antenna, or any other components that are suitable for sending and receiving wireless communication signals. The first wireless apparatus may be portable or small enough that a user can keep it on them or near them at all times. The first wireless apparatus may also comprise components that allow it to alert a user if it enters an alarm condition.

A “second wireless apparatus” can include any electronic device that includes a means for communicating with the first wireless apparatus. The second wireless apparatus can also include an interface element for electrically coupling with another electronic device (i.e. mobile device, portable electronic device, or mobile communication device). The second wireless apparatus may communicate with the mobile communication device through the interface element and may control the behavior of the mobile communication device and the mobile communication device may control the behavior of the second wireless apparatus. In some embodiments, the second wireless apparatus may include or be part of a mobile communication device case such that the second wireless apparatus surrounds the mobile communication device when engaged. The case may provide protection for the mobile communication device and ensure the second wireless apparatus cannot be easily removed from the mobile communication device by an unauthorized third party.

A “mobile communication device” can include any electronic device that includes a means for communicating with other electronic devices. The mobile communication device may include a mobile phone, tablet, digital music player, netbook, laptop, or any other electrical device that comprises a means for wireless communication. The mobile communication device may be electrically coupled to the second wireless apparatus through a mobile communication device interface element. The mobile communication device and the second wireless apparatus may share information through the mobile communication device interface element when electrically coupled together. For example, the information may comprise commands, data to be stored on a memory, or any other information that may control the behavior of the mobile communication device, first wireless apparatus, or second wireless apparatus. While the description below focuses on mobile communication devices, aspects of the invention may be implemented with any portable device and should not be limited to mobile communication devices alone.

A “mobile communication device interface element” can include any input or output component that allows two electronic devices to be electrically and removably coupled together. For example, the mobile communication device interface element may be contained on either the mobile communication device or the second wireless apparatus. Furthermore, the electronic device that does not comprise the mobile communication device interface element may be configured to interact with the mobile communication device interface element. For example, if the mobile communication device interface element is a male connector located on the second wireless apparatus, the mobile communication device may be configured to couple with the mobile communication device interface element through a female connector or other comparable input/output component. The mobile communication device interface element may be a generic input type managed by a standards body (e.g. USB™, MicroUSB™, etc.) or may be proprietary or specially designed for the particular model of mobile communication device (e.g. Apple™ iPhone™ connector).

A “wireless signal request” can include any communication signal, data message, data package, or data stream sent by an electronic device requesting a response from another electronic device. For example, the second wireless apparatus may send a wireless signal request to the first wireless apparatus requesting a response message from the first wireless apparatus. The wireless signal request may comprise commands, state or operational information, responses to a previous communication received from the first wireless apparatus, or any other data that would be useful to share between electronic devices. The information may be shared through any suitable communication scheme including cellular network communication, short-range communications (e.g. Bluetooth™ or other near-field communication), internet or WI-FI communications, or any other suitable communication scheme as would be recognized by one of ordinary skill in the art.

A “wireless signal response” can include any communication signal, data message, data package, or data stream sent by an electronic device in response to a wireless signal request received from another electronic device. For example, the first wireless apparatus may send a wireless signal response back to the second wireless apparatus in response to a wireless signal request. Similar to the wireless signal request, the wireless signal response may comprise commands, state or operational information, responses to a previous communication received from the second wireless apparatus, or any other data that would be useful to share between electronic devices. The information may be shared through any suitable communication scheme including cellular network communication, short-range communications (e.g. Bluetooth™ or other near-field communication), internet or WI-FI communications, or any other suitable communication scheme as would be recognized by one of ordinary skill in the art.

In embodiments of the present invention, “synchronizing” can include the initialization, pairing, and initial communication between two or more electronic devices. The synchronizing may occur through different communications means between different devices. For example, a first wireless apparatus may synchronize with a second wireless apparatus through a wireless communication but the second wireless apparatus may synchronize with the mobile communication device through an exchange of information using a mobile communication device interface element. Additionally, synchronizing may include any one of the initialization, pairing, and initial communication between the electrical devices or may include all of the steps. Either way, once devices are synchronized, the devices may communicate requests, commands, and responses between each other.

A “data input” can include any input by a user on an electrical device. For example, the data input may be the touching of a particular area of a display screen that is configured to send a particular command to the processor of an electrical device (e.g. touch screen input) or may include the compression or engagement of a physical button or input on an electrical device (e.g. power button, volume up or down button, etc.). In embodiments of the present invention, data inputs may include commands to enter operational modes, engage or disengage features, control the volume, change screen display settings, navigate through an application or operating system, or may be used to provide consumer information including a password, as well as implementing any other features that may be useful in the present invention.

A “transmission range” can include a maximum distance that a transmitter of an electrical device is programmed to transmit or capable of transmitting a recognizable signal. For example, a transmission range may be the maximum distance that a transmitter may send a communication package that is still recognizable by another electrical device with a receiver or transceiver configured to receive the communication package or message, using maximum power. Alternatively, the transmission range may be the maximum distance that a transmitter or transceiver component or device may transmit a data packet or message at a given programmed power level. For example, transmitters or transceivers may have multiple power levels that limit the transmission distance of the transmitter or transceiver. The power levels may be set for a long or short range transmission or may be programmed for many different ranges corresponding to many different power levels through an application running on the mobile communication device. For example, the user can select a “long” option, where the communication range may be at a maximum of, for example, 30 feet, or a “short” option, where the communication range may be about 50% of the maximum. When the find key or find phone states are active, the communication range may have a default setting of “long.” The separation range may be set through limiting the power output of the transceiver or through any other suitable method as one of ordinary skill in the art would recognize. In this manner, the short setting could also provide battery savings as well as increased security. Additionally, the range settings may be set in any suitable manner such as, for example, five different settings beginning with a range of ten feet and each subsequent setting extending the range by five feet. Any suitable number or method of setting the transmission range of the system may be implemented as one of ordinary skill would recognize.

“Alerting a user” can include any actions taken by an electronic device to get a user's attention. For example, these actions may include generating audible alarms, physical vibrations, flashing lights, sending emails or short messages (SMS) or status updates (through social media websites like Twitter™) initiated from either wireless apparatus or the mobile communication device. The actions may be initiated by commands, messages, or signals generated by any of the devices. For example, a second wireless apparatus may determine that a tamper switch is triggered and send an alarm command to the first wireless apparatus which subsequently enters an alarm condition that may include activating flashing lights on the first wireless apparatus, making a noise, vibrating, or any other action to get the user's attention. If the first wireless apparatus is in the user's pocket, hand, or within eye sight, the user will sense the movement, hear the noise, or see the flashing and will be alerted that the second wireless apparatus sent an alarm command and the first wireless apparatus has entered an alarm condition. Additionally, the system may develop different alerting modes for different types of alarms (e.g. a tamper alarm may cause a chirping noise while an alarm related to losing contact with the second wireless apparatus will cause a beeping noise, or different colored lights could be lit for each type of alarm, etc.).

In embodiments of the present invention, “locking a mobile communication device from use,” can include setting a mobile communication device to any secure state where the data on the mobile communication device cannot be accessed until the alarm condition ends. For example, locking a mobile communication device from use may include sending a command to the mobile communication device to enter a sleep mode, disabling the screen such that the device will no longer respond to user input, requiring the user to enter a password (either numeric, audible, piezoelectric, etc.) using the mobile communication device before any functionality is activated, setting the mobile communication device to an unresponsive state until the first wireless apparatus is brought within range of the mobile communication device, or any other suitable secure state where the data on the mobile communication device cannot be accessed until the mobile communication device is unlocked or the alarm condition is remedied. In some embodiments of the invention, it may be desirable that the alarms for the second wireless apparatus and first wireless apparatus be independently disabled while the locking functionality remains intact.

### I. Exemplary Systems

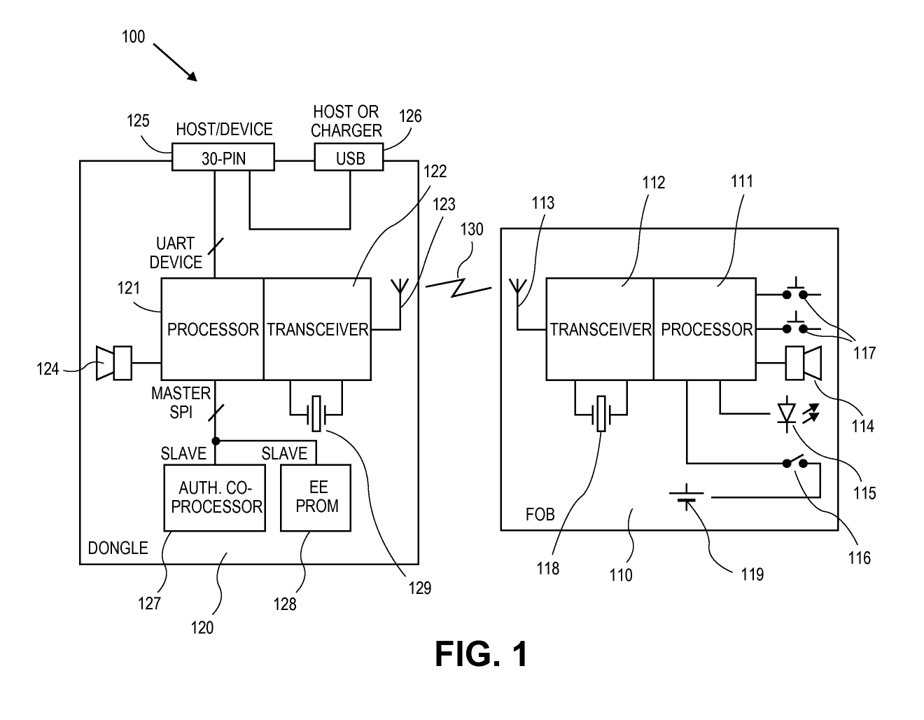

FIG. 1 shows a block diagram in accordance to embodiments of the invention. Embodiments of the invention relate to a security system 100 comprising two parts: a first wireless apparatus 110 (e.g. a key, fob, etc.) and a second wireless apparatus 120 (e.g., dongle, case, etc.) attached to a protected unit or mobile device (not shown). The protected unit may be a mobile phone, mobile communication device, or any other portable computing device such as a tablet computer.

The first wireless apparatus 110 may comprise a processor device 111 (e.g. a microcontroller or microprocessor), a transceiver device 112, and an antenna 113 coupled to the transceiver device 112. The transceiver device 112 may be a chip, card, or any other device comprising both receiver circuitry and transmitter circuitry capable of sending and receiving communication messages using the antenna 113, and may implement any suitable communication protocol. A crystal oscillator 118 may provide a clock for the transceiver device 112. The transceiver device 112 may be coupled to the processor 111. The processor 111 may also be coupled to input components 116, 117 (e.g. buttons, switches, microphone, or any other input component) and output components 114, 115 (e.g. a speaker, a light emitting diode (LED), vibrating element, etc.).

Input components 116, 117 may be user interfaces that allow the user to control the functionality of the first wireless apparatus 110. For example, input components 117 may include buttons that activate certain functionality (e.g. mobile device finder, mute, etc.) for the first wireless apparatus 110. Additionally, the input component 116 may include a power switch that controls the connection to a power source 119 and turns the first wireless apparatus 110 on and off.

Output components 114,115 may be any mechanisms for alerting a user (e.g. a buzzer, vibrator, LED light, etc.). For example, in FIG. 1 the output component 114 is a speaker and output component 115 is a LED. Any suitable output can be implemented and the output components should are not limited to those shown in FIG. 1.

The second wireless apparatus 120 may be in the form of a case (with or without an embedded power source) or merely an independent dongle or other independent hardware device without a power source. FIG. 1 shows the block diagram of a second wireless apparatus 120 in the form of a dongle. A dongle is a hardware component that may be required for a processor to run a software program as the processor verifies the dongle is present during initialization of the program and may communicate with the dongle during operation of the application.

The second wireless apparatus 120 may comprise a processor 121 (e.g. microcontroller or microprocessor), a transceiver device 122, and an antenna 123 coupled to the transceiver device 122. The transceiver device 122 may be a chip, card, or any other device comprising both receiver circuitry and transmitter circuitry capable of sending and receiving communication messages using the antenna 123, and may implement any suitable communication protocol. A crystal oscillator 129 may provide a clock for the transceiver device 122. The transceiver device 122 may be coupled to the processor 121.

The transceivers in the first wireless apparatus 110 and second wireless apparatus 210 are configured to communicate 130 with one another and may implement an over-the-air addressing communication protocol. The over-the-air addressing may include, for example, up to five bytes of address in the header of each packet allows packets to be addressed to individual destinations, and allows second wireless apparatuses 120 to only respond to packets addressed to them. The device addresses may be generated from a fixed, system-wide, 2-byte prefix plus device-unique 3-byte suffix. Because the address occurs first in the packet, the address effectively forms the sync sequence. Adopting a fixed prefix allows beneficial correlation properties and avoids problems related to false syncing that may occur through random addressing schemes. Furthermore, the three bytes of device address gives 1.6 million unique addresses which gives a sufficiently low probability of collisions between co-located devices. Additionally, a network monitor (“sniffer”) may be constructed, responding to any address beginning with the prefix. If the whole address field were unique it would not be possible to construct a network monitor without having it respond to every transceiver transmission in the vicinity (and a lot of noise), or knowing a priori which transmissions to listen for. Similarly, by re-configuring a second wireless apparatus 120 to respond to the prefix the second wireless apparatus 120 can receive transmissions from all first wireless apparatuses in the vicinity. This may be beneficial during the pairing procedure if the multiple-pairing feature is to be implemented.

The second wireless apparatus 120 may further comprise a mobile communication device interface element 125 as well as a power supply interface element 126. In some embodiments, the mobile communication device interface element 125 may comprise the power supply interface element 126 (e.g. Apple™ iPhone™ connector as shown). In FIG. 1, the mobile communication device interface element 125 may be used to physically, removably, and electrically couple to a mobile communication device (not shown) for power and data exchanges. Although the mobile communication device interface element 125 is listed as a 30-pin connector in the diagram, it is not limited to such a configuration. The mobile communication device interface element 125 may be configured for any mobile communication device using connectors provided by standards groups (e.g. USB™) or proprietary connectors (e.g. Apple™ iPhone™ connector). FIG. 1 shows a connector for an Apple™ iPhone™ and as such, the 30-pin connector is shown. In the embodiment shown in FIG. 1, the dongle does not comprise a power supply and as such, the dongle may receive power through the power supply interface element 126 that is coupled to the mobile communication device interface element 125. The dongle may also receive power through any other external power source as one of ordinary skill in the art would recognize.

The second wireless apparatus 120 may also comprise an authentication co-processor 127 that authenticates the second wireless apparatus 120 to the operating system of the mobile communication device (not shown). The second wireless apparatus 120 may contain circuit and algorithms to authenticate itself to the mobile communication device (not shown). Authenticated control signals and data may be transmitted between the two devices. This strengthens the security against non-physical tampering. On some mobile devices and operating systems, this also allows broader access to the mobile device. The processor 121 may be connected via the mobile communication device interface element 125 to the standard universal asynchronous receiver/transmitter (UART) interface of the mobile communication device. An electrically erasable programmable read-only memory (EEPROM) 128 connected to a serial peripheral interface (SPI) bus may provide for non-volatile storage of configuration parameters. An output component 124 (e.g. speaker) provides an output alarm when the second wireless apparatus 120 is out of the range of the first wireless apparatus 110. Input for configuration of the second wireless apparatus 120 and the first wireless apparatus 110 may be via an application running on the mobile communication device (not shown) that will communicate with the second wireless apparatus 120 through the mobile communication device interface element 125. The second wireless apparatus 120 may be powered from the power supply interface element 126 that may be coupled to or included within the mobile communication device interface element 125, e.g., the 30-pin connector mobile communication device interface element 125 in the exemplary embodiment includes a power supply interface element 126 as well.

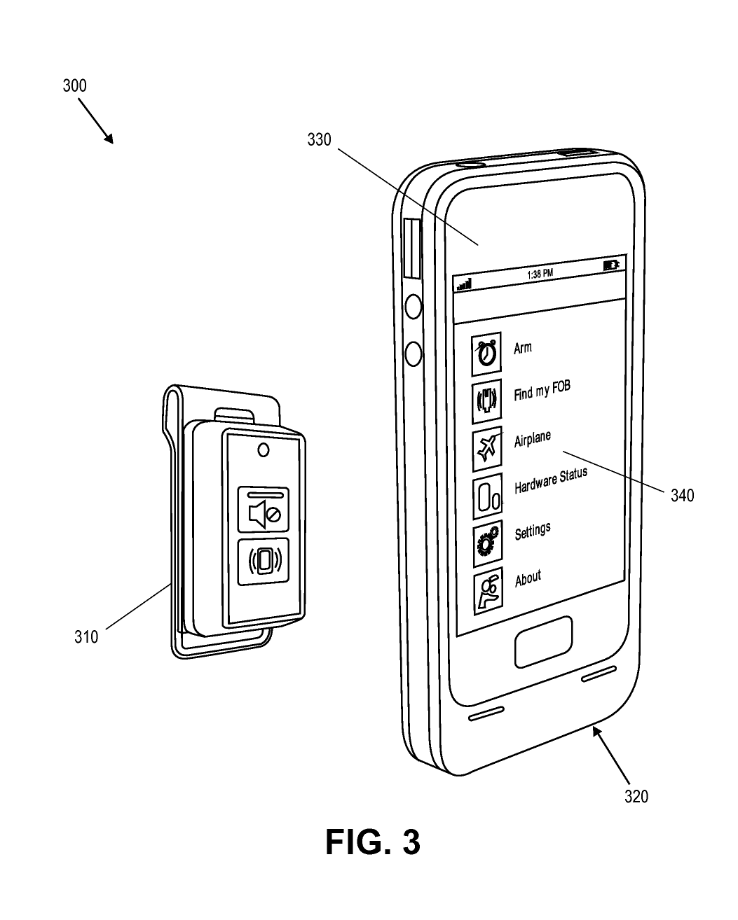

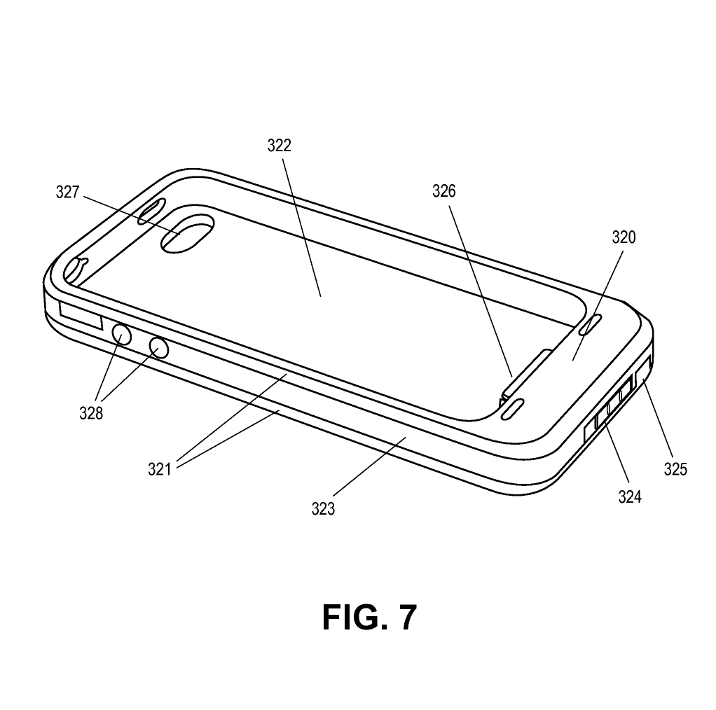

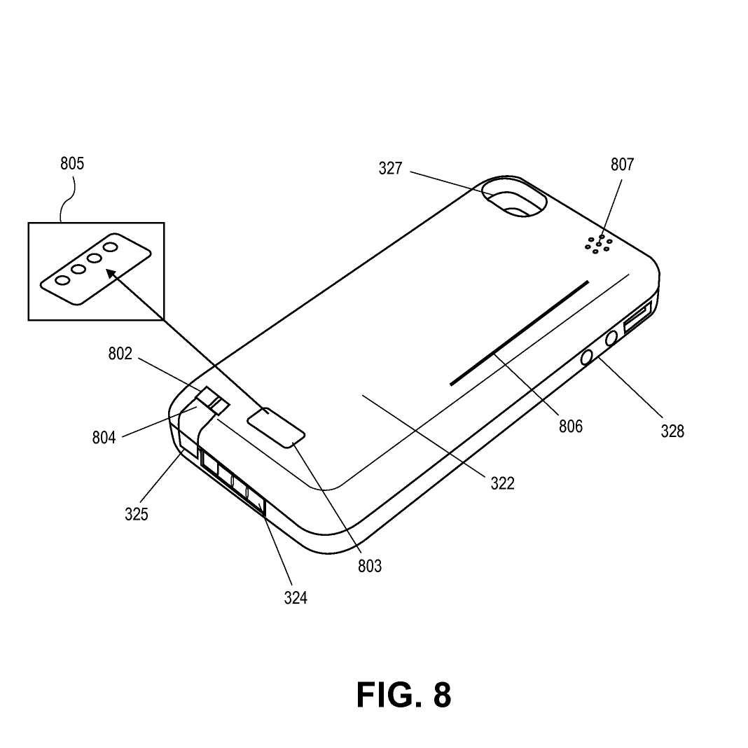

The second wireless apparatus 120 may be designed so that it is small enough to be incorporated into a case for a mobile communications device such as an iPhone™. Due to the industrial design of mobile communication devices, it would be preferable that the electronics fit into the space of the outer band with minimal coverage of the front and back sides of the mobile communications device (not shown). Exemplary second wireless apparatuses 320 are shown in FIGS. 3-6, exemplary methods of securing a mobile communication device (e.g., iPhone™) into the second wireless apparatus 320 are shown in FIGS. 7A-8B.

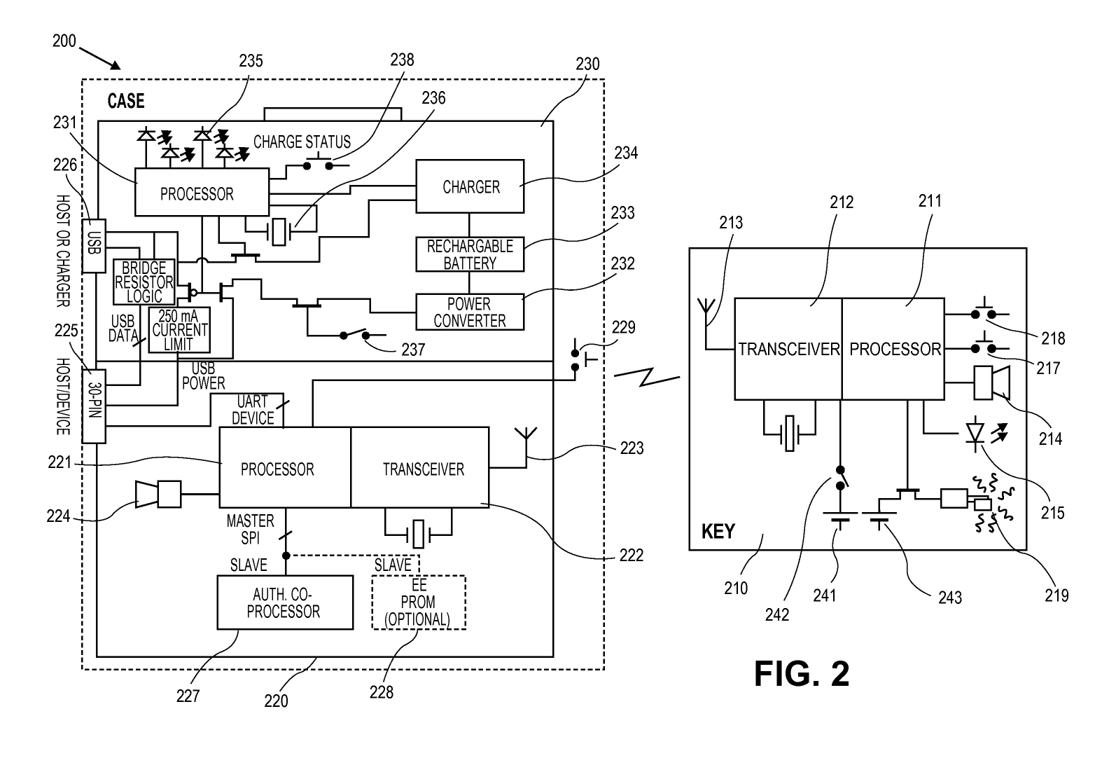

FIG. 2 shows an exemplary block diagram of a security system according to embodiments of the invention where the first wireless apparatus 210 is a key and the second wireless apparatus 220 is a case for a mobile communication device (not shown) and includes a rechargeable battery 233.

The second wireless apparatus 220 (e.g., case) comprises a transceiver 222 and may be in communication with an application running on the mobile communication device's operating system and a co-processor 227 via a mobile communication device interface element 225 (e.g. 30-pin connector) compatible with the mobile communication device (not shown), or through any other removably and electrically coupled means. The transceiver 222 in the second wireless apparatus 220 (e.g., case) is wirelessly and electrically coupled to a first wireless apparatus (e.g., key) 210 that the user carries. When the mobile communication device (not shown), that is physically and electrically coupled to the second wireless apparatus 220 (e.g., case), is moved a particular distance from the first wireless apparatus 210 carried by the user, the first wireless apparatus 210 may alarm and alert the user using the output components 214-215, the second wireless apparatus 220 may alarm using the output components 224 as well, and may lock the mobile communication device (not shown) from use.

The second wireless apparatus 220 may comprise a power supply 233 (e.g. rechargeable battery), a transceiver 222, and other electronic circuits. The second wireless apparatus 220 is physically secured, removably, and electrically coupled to the protected mobile electronic device (not shown) for power and data exchanges through the mobile communication device interface element 225. A tamper detection mechanism 229 may monitor unexpected removal of the second wireless apparatus 220 from the mobile communication device (not shown) and other forms of physical intrusion. A software interface, such as an application, that may be executed by the mobile communication device may handle the configuration of the system, change parameters such as the transmission range of the first and second transceivers by communicating through the mobile communication device interface element 225 with the second wireless apparatus 220, and defining alarm conditions and responses.

The second wireless apparatus 220 further comprises an embedded rechargeable power supply device 230 comprising a separate processor 231, a charger 232, a rechargeable power supply 233 (e.g. rechargeable battery), a power converter 234, one or more power level indicators 235 (e.g. LEDs, lights, display screen, or other indicator), a crystal oscillator 236 coupled to the processor 231 to provide a clock for the processor 236, and a power switch 237 for the rechargeable power supply device 230 to allow the use of the rechargeable power supply 233 to power the second wireless apparatus 220 or the mobile communication device (not shown), a battery status button 238 to control the power level indicators 235 and cause them to momentarily light up, and other circuit elements that one of ordinary skill in the art would recognize as useful or necessary when implementing the current functionality.

The second wireless apparatus 220 may be powered by the rechargeable power supply 233 by switching the power switch 237 which connects the power converter 232 and the rechargeable power supply 233 with the power supply interface element 226 and subsequently the processor 221 of the second wireless device 220. Additionally, in some embodiments, the power switch 237 may be used to enable or disable the charging of the power supply of the mobile communication device (not shown) by the rechargeable power supply 233 through the power supply interface element 226. When the rechargeable power supply's 233 power levels have been depleted entirely or in part, the rechargeable power supply device 230 may be recharged by connecting an external power supply (not shown) to the power supply interface element 226, which is connected to the charger 234 and the rechargeable power supply 233. Additionally, the second wireless apparatus 220 may be powered through the mobile communication device interface element 225 or the power supply interface element 226 independently of the rechargeable power supply device 230. The second wireless apparatus 220 may automatically select the power source and may switch sources according to built-in algorithms. The built-in rechargeable power supply 233 of the second wireless apparatus 220 allows the mobile communication device (not shown) to be powered off, its battery to be drained, or the second wireless apparatus 220 to be removed, without complete loss of functions of the second wireless apparatus 220.

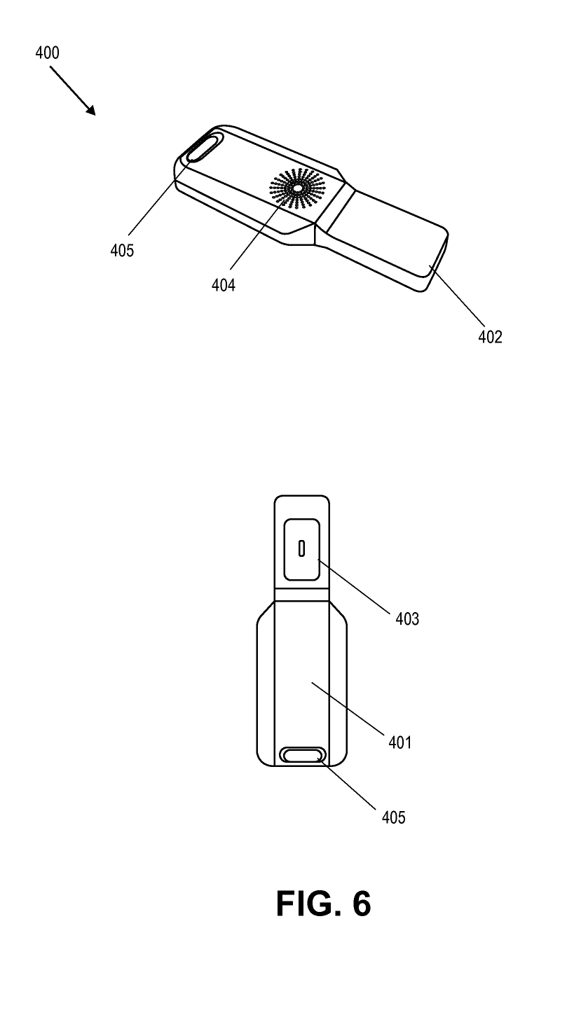

The second wireless apparatus 220 otherwise operates as described in reference to FIG. 1. Furthermore, the first wireless apparatus 210 comprises similar components to those described in reference to FIG. 1 but is in the form of a key. Additionally, the first wireless apparatus 210 further comprises a buzzer or vibration motor 219 that causes the first wireless apparatus to vibrate, buzz, or otherwise create a physical sensation to alert the user in the case that the audio and visual alerts are not sufficient. The first wireless apparatus 210 may further include a vibration motor power source 243 that powers the vibration motor 219. Additionally, the first wireless apparatus 210 may comprise a power switch 242 that may control a connection to a first wireless apparatus power source 241 and turns the first wireless apparatus 210 on and off. Accordingly, the first wireless apparatus 210 operates in the same manner and comprises the same functionality as described above in reference to FIG. 1. Furthermore, the key may comprise any other components or elements that a typical key would, including a communications element (not shown), if the key implements contactless operations for other devices. Exemplary embodiments of the key are provided in FIG. 6.

Additionally, both the second wireless apparatus 220 and first wireless apparatus 210 may require non-volatile storage for parameters, at least serial number and pairing information, and possibly also configurable settings such as beeper volume. For example, the transceiver 222 in the second wireless apparatus 220 may comprise flash memory including up to two pages intended for storage of data. The processor 221 can erase and write to this memory. However, use of this memory for configuration parameters is problematic because erase/write operations halt the processor for significant periods (e.g. ˜70 ms for a single page erase/write at 8 MHz). For this reason the second wireless apparatus 220 may include an EEPROM device 228 to hold configuration parameters. A small, low-cost device such as a 128-byte device may be implemented.

Furthermore, the first wireless apparatus 210 the transceiver device 112 may comprise flash memory intended for data. Although erasing and writing flash takes time there is no problem with the first wireless apparatus 210 being unresponsive to inputs for a short period. Therefore in the first wireless apparatus 210 the on-chip flash can likely be used for configuration parameters and an external EEPROM chip (not shown) is not required. The transceiver 212 may further comprise an analog digital converter (ADC) that may be suitable for measuring the battery voltage. The processor 231 on the second wireless apparatus battery circuit 230 may have a similarly suitable ADC.

Furthermore, both the second wireless apparatus 220 and first wireless apparatus 210 may store parameters in a non-volatile storage, at least serial number and pairing information, and preferably also configurable settings such as beeper volume.

FIG. 3 shows a perspective view of an exemplary embodiment of the security system comprising a first wireless apparatus 310, a second wireless apparatus 320, and a mobile communication device 330 where the first wireless apparatus 310 is in the form of a fob, the second wireless apparatus 320 is in the form of a case, and the mobile communication device 330 is an Apple™ iPhone™. An exemplary screen shot of a security application 340 that may be used to initiate, configure, and operate the security system is being shown on the mobile communication device 330. The functionality, components, and operation of the first wireless apparatus 310, the second wireless apparatus 320, and the application 340 running on the mobile communication device 330 of the security system will now be described in further detail below.

### The First Wireless Apparatus

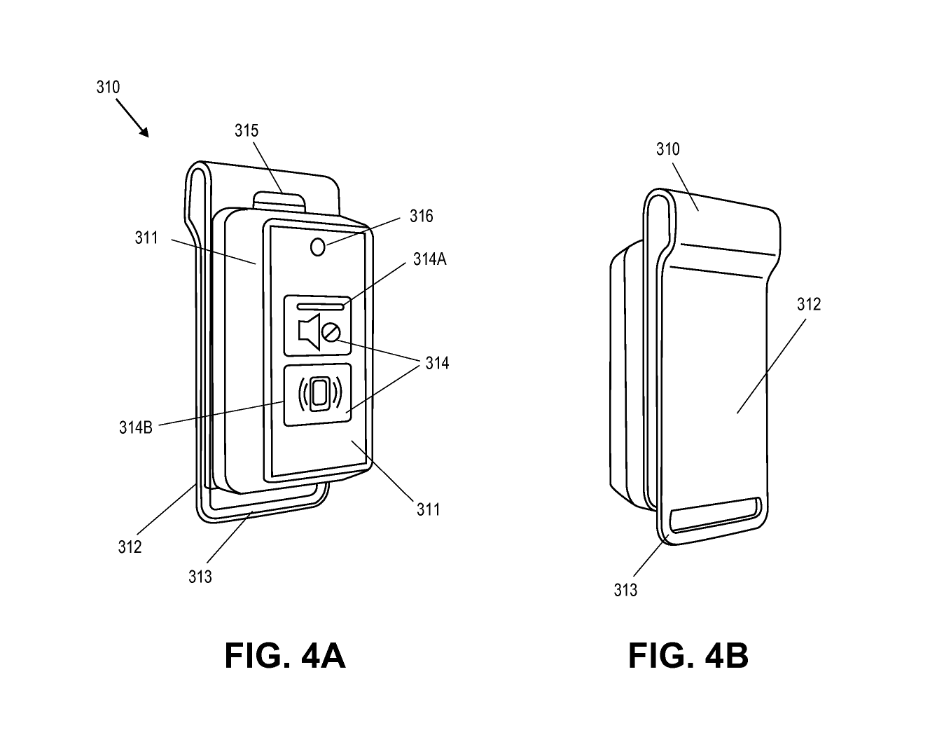

According to embodiments of the invention, the first wireless apparatus 310 may be as thin and as small as possible. Smaller dimensions allow the first wireless apparatus 310 to be easily transported and carried by the user at all times without inconveniencing the user. Additionally, the first wireless apparatus 310 should be constructed appropriately so that it may be attached to a personal item that the user will always be in possession of and may not likely misplace. The first wireless apparatus 310 may also be constructed so that it may be attached to the clothing of a user (e.g. a belt clip that can be attached to a user's belt, pants, etc.) or attached to an accessory that will be worn by a consumer (e.g. a lanyard, tie clip, etc.). Exemplary first wireless apparatuses 310 may be a fob capable of being attached to a keychain (shown in FIGS. 4A-4B), or a device capable of being attached to an existing first wireless apparatus 400 (e.g. the key shown in FIG. 6), or any other apparatus capable of being attached to a personal item carried by the user.

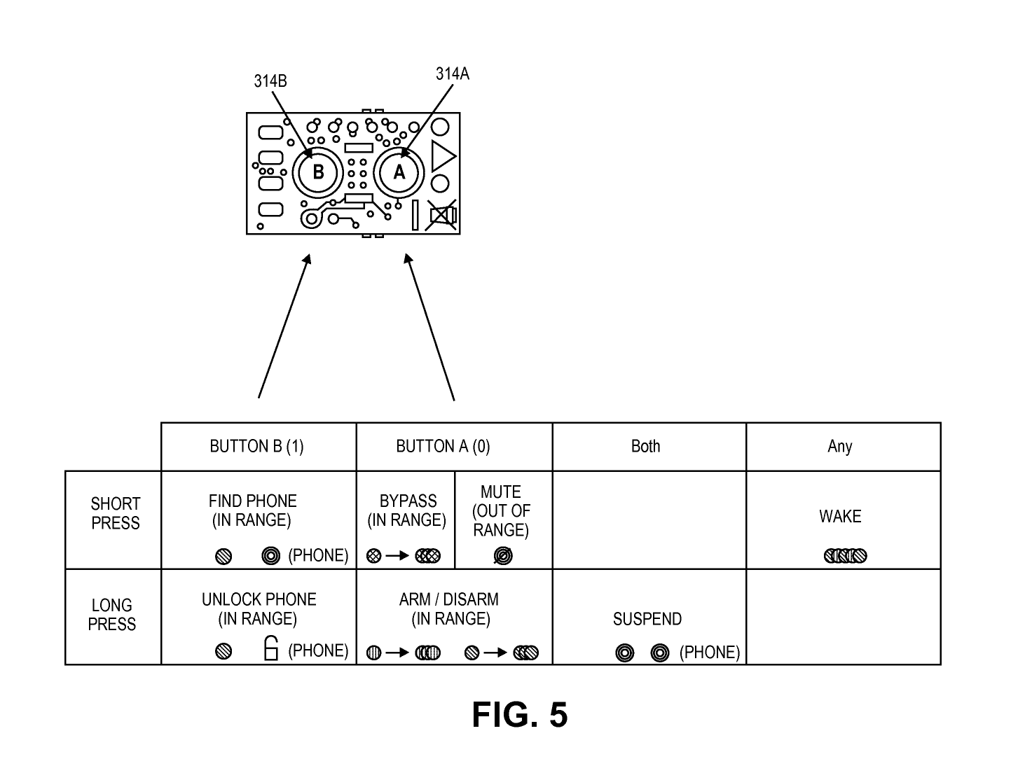

FIGS. 4A-6 show an exemplary embodiment of a first wireless apparatus 310 according to embodiments of the present invention. FIGS. 4-5 show an exemplary embodiment of the first wireless apparatus 310 in the form of a fob. FIG. 6 shows various views of an exemplary embodiment of the first wireless apparatus 400 in the form of a key. The first wireless apparatus is not limited to such implementations and could be in the form of any portable device or the functionality of the first wireless apparatus may be implemented into or combined with another portable device for consumer use.

FIGS. 4A and 4B show perspective views of an exemplary first wireless apparatus 310 according to an embodiment of the invention. The first wireless apparatus 310 may comprise an outer case 311, a belt clip 312, a keychain hole 313, input buttons 314, a power switch 315, and status LED indicators 316. The keychain hole 313 may be integrated into the belt clip 312 (as shown) and the belt clip 312 may be physically coupled to the outer case 311. The belt clip allows the first wireless apparatus 310 to be attached to a user's pants, shirt, belt, or any other clothing that fits into the space between the outer case 311 and the belt clip 312. Additionally, the keychain hole 313 allows a keychain or other attachment device to engage with the keychain hole 313 and attach the keychain to the first wireless apparatus 310. Any other configuration could also be implemented, for example, the keychain hole 313 may be integrated into the outer case 311 and no belt clip 312 could be provided.

The power switch 315 may turn the power on and off of the first wireless apparatus 310. The input buttons 314 may allow for user input that may control the behavior and functionality of the first wireless apparatus 310. Additionally, status LED indicators 316, a sounder (not shown), and a vibration motor (not shown) may provide output to a user. The first wireless apparatus 310 may be powered by batteries (e.g., a rechargeable Li-ion/Li-poly cell) (not shown). The input buttons 314 may provide different functionality, for example, the first wireless apparatus 310 of FIG. 4A has a mute button 314A and a find phone button 314B. The functionality and capabilities of each button are explained in further detail below in reference to FIG. 5.

FIG. 5 shows an exemplary first wireless apparatus 310 chip and button function chart according to an embodiment of the invention. The first wireless apparatus 310 may comprise two input buttons 314, an A button 314A and a B button 314B. The buttons may perform different functions depending on the period of time that a button is pushed or engaged. For example, as shown in the button function chart of FIG. 5, the buttons 314 may perform different functionality depending on whether the button is engaged by the user in a short press or a long press. The user may also press Button A and Button B in certain combinations in order to perform different functions.

As can be seen from the chart, a single or short press on button A activates a “Mute Alarm” function, which sets the first wireless apparatus 310 to alert the user through a vibration instead of an audible alarm using the speaker. Accordingly, when the system is in an armed mode and the second wireless apparatus 320 goes out of range of the first wireless apparatus 310, the first wireless apparatus 310 would be triggered and a warning and/or alarm would be activated within the first wireless apparatus 310 using a buzzer, vibration motor, LED lights or any other component that may alert the user without making noise. The buzzer or vibration motor on the first wireless apparatus 310 may silence for the extent that the first wireless apparatus 310 and second wireless apparatus 320 are out of range after the mute alarm button has been pushed. However, once the first wireless apparatus 310 and second wireless apparatus 320 are brought back into range of one another, the alarm features may reset.

Additionally, the mute button may change functionality depending on whether the first wireless apparatus 310 is in range of the second wireless apparatus 320 at the time it is entered. Accordingly, if button A is pressed after the first wireless apparatus 310 is already out of range of the second wireless apparatus 320, the audible or visual alarms may be ended because the user is acknowledging receipt of the alarm functionality. As such, the first wireless apparatus 310 may maintain the alarm condition but may end the alert functionality or may alter the alert functionality such that the device only reminds the user over a longer period (more infrequently) that the first wireless apparatus 310 is in an alarmed mode. In some embodiments of the invention, it may be desirable that the alarm on the second wireless apparatus 320 be muted via the application running on the mobile communication device in the event that the first wireless apparatus 310 cannot enter the appropriate range in a reasonable time or the battery on the first wireless apparatus 310 has drained. Accordingly, in some embodiments, the application may allow a user to bypass the locking of the mobile communication device through the use of a password or other verification of the user, and the first wireless apparatus alarm may be disabled through the application running on the first wireless apparatus.

In contrast, a single press on button B 314B may activate a “find phone” feature. The find phone feature may cause the first wireless apparatus 310 to send a command to the second wireless apparatus 320 to initiate notification responses from the second wireless apparatus 320 to help the user determine where the second wireless apparatus 320 (which is coupled to the mobile communication device (e.g. phone)) is located. In some embodiments, the user may be notified of the distance to the second wireless apparatus 320 by the first wireless apparatus 310. The user could be notified through any suitable means including a voice informing the user through the output component speaker, distance displayed on a screen on the first wireless apparatus 310, or any other suitable means. The distance may be determined using a signal strength, or power approximation scheme or any other suitable means to estimate distance as one of ordinary skill in the art would recognize. The “find phone” feature will be discussed in further detail below.

If both button A 314A and button B 314B are pressed and held for an extended period of time (e.g. 3 seconds) at the same time the first wireless apparatus 310 may be suspended or un-suspended. If the system is active and both button A 314A and button B 314B are pressed and held, the first wireless apparatus 310 may enter the suspend mode by sending a command to the second wireless apparatus 320 to suspend the security system. The first wireless apparatus 310 may confirm the sending of the command or the entering of the suspended mode to the user by making sounds, vibrating using the buzzer, flashing the LED status indicators, or any other output to confirm to the user that the suspend operation was successful. If the system is already in a suspended mode when both button A 314A and button B 314B are pressed and held, the first wireless apparatus 310 may come out of suspended mode by powering up and by sending a power up command to the second wireless apparatus 320. The suspend mode and subsequent functionality and operations of the first and second wireless apparatus 320 during the suspended mode will be described in further detail below.

The first wireless apparatus 310 may also unlock the phone by holding button B down for a long press while in range of the second wireless apparatus 320. Once the first wireless apparatus 310 determined that button B had been pressed for the requisite period of time, the first wireless apparatus 310 sends an unlock command to the second wireless apparatus 320. The second wireless apparatus 320 then sends a command to the mobile communication device through the mobile communication device interface element 225 to unlock the mobile communication device. Unlocking the phone for use may mean that the phone is operable and interactive with the user. For example, unlocking the phone may mean that the user may interact with the input devices (e.g. keyboard or touch screen) without having to input any other password or sign on. In some embodiments, unlocking may mean the functionality is unlocked but the user may still need to input a password or code to gain access to the phone. In some embodiments, the unlock command may counter-act the lock command sent by the second wireless apparatus during an alarm condition as well.

The first wireless apparatus 310 may use status LED indicators 316 as an output display to the user. There may be 3 color states: Red, Green, and Yellow (both Red and Green on together, piped). The status LED indicators 316 may inform the user of the current status of the system or the first wireless apparatus 310, or may be used to inform the user of a warning condition or an alarm condition. For example, the status LED indicators 316 may flash an alternating pattern of red and green for two seconds when powering or starting up and may blink green three times when communication has been established between the first and second wireless apparatus 320 after powering up (i.e. the first wireless apparatus 310 and the second wireless apparatus 320 have been “paired). The status LED indicators 316 may blink green once when the first wireless apparatus 310 enters an armed mode and may blink yellow once when the first wireless apparatus 310 enters a disarmed mode. Additionally, the status LED indicators 316 may blink red three times when the first wireless apparatus 310 is suspended as a result of a command from the second wireless apparatus 320 and may blink red once when the first wireless apparatus 310 initiates the suspended mode and commands the second wireless apparatus 320 to enter a suspended mode. Furthermore, the status LED indicators 316 of the first wireless apparatus 310 may blink another three times red when the first wireless apparatus 310 receives a signal from the second wireless apparatus 320 acknowledging that the second wireless apparatus 320 has entered a suspended mode or after timing out waiting for an acknowledgement. The status LED indicators 316 may further blink yellow once when the Mute button (e.g. Button A) is pressed for a short time while in range of the second wireless apparatus 320. Furthermore, when the find phone button is pressed the once the status LED indicators 316 may flash a green light once. Finally, when the battery is in a designated low or dying state, the status LED indicators 316 may blink every ten seconds to alert the user that the battery is low.

FIG. 6 shows perspective views of an exemplary first wireless apparatus 400 according to an embodiment of the invention where the first wireless apparatus 400 is in the form of a key. The first wireless apparatus 400 comprises a body 401, a contactless key section 402, an input button 403, a output speaker 404, and a keychain hole 405. In some embodiments, the key may also comprise a vibrator motor (not shown). Although the key 400 provides a single input button instead of two buttons, similar functionality as described above may be implemented by programming the key 400 to have multiple states (e.g. when alarming the key will act as a mute button, when armed will act as a finder button, etc.) and can also implement different functions depending on whether the button 403 is held down for a long period of time or a short period of time, as described above in regards to the button function chart of FIG. 5.

### The Second Wireless Apparatus

The second wireless apparatus 320 may be configured as either a case, dongle, may be incorporated into a mobile communication device 330 at the manufacturing stage, or may be implemented in any other suitable form. FIG. 7 shows a front perspective view of an exemplary embodiment of the second wireless apparatus 320 as a case for the iPhone™. The second wireless apparatus 320 (e.g., case) may provide both protection and security to a mobile communication device 330. To prevent interference with the second wireless apparatus 320 transceiver, the portion of the second wireless apparatus 320 (e.g., case) that houses the mobile communications device may be made of some strong plastic. Sound “scoops” may allow for directionality of the mobile communication device's 330 microphone and speaker towards the speaker so as to not reduce their performance with second wireless apparatus 320 attached. The second wireless apparatus 320 may provide protection for the mobile communication device 330 by making the case's outer band 401 surrounding the mobile communications device may be made of rigid material, lined with a non-conductive and mild shock absorbing material. A strong plastic may be the preferred outer material.

The case 320 may comprise an outer band that securably surrounds a mobile communication device 330 and provides a large area that the mobile communication device's 330 display can be seen and interacted with by a user. The case 320 may include a back portion that includes a hole for a camera or is configured to allow any pre-existing functionality on the mobile communication device 330 to be used. Additionally, the case 320 may include input buttons that align with the mobile communication device's 330 input buttons so that the mobile communication device 330 may be interacted with as originally designed by the manufacturer. The inside of the case 320 may include a mobile communication device interface element 326 that is configured to removably and electrically couple with the mobile communication device 330 as described above in reference to FIGS. 1 and 2. Here, the mobile communication device interface element is a 30 pin Apple™ connector that is designed to removably and electrically couple to a iPhone™. As explained above, the mobile communication device interface element allows the second wireless apparatus 320 to communicate and control the iPhone™. Finally, the bottom of the case 320 may include a slider lock 324 and a power supply interface element 325.

The slider lock 324 may be designed to require a user to slide the slider lock 324 away from the resting position in order to open the case 320 to remove the mobile communication device 330. The slider lock ensures that the case 320 does not accidentally open and secures the mobile communication device 330 within the case 320 until the user wants to remove the mobile communication device 330 from the case 320. The slider lock may be implemented in any suitable manner. In one embodiment, the slider lock may have an overlapping element (not shown) within the inside of the case 320 that ensures the front and the back portion of the case 320 cannot be separated unless slide to the correct position. The overlapping section may overlap the front and back portions of the case 320 unless the slider lock is moved to a position where the overlapping element no longer overlaps the front and back portions and allows the portions to be separated. Any other suitable lock may be used to ensure the mobile communication device 330 is secure within the case 320 and the case 320 does not become separated from the mobile communication device 330 accidentally.

The power supply interface element port 325 may be configured to allow an external power supply to be electrically coupled to the second wireless apparatus 320 power supply interface element as described above in reference to FIGS. 1 and 2. As explained above, the power supply interface element 325 may be configured to accept any type of suitable external power supply (e.g. USB™, microUSB™, etc.). The embodiment shown in FIG. 7 has a microUSB™ connector. The power supply interface element 325 may be used to charge the power supply (e.g. rechargeable battery) of the second wireless apparatus 320 and may also be used to synchronize data with an external device (e.g. laptop, computer, tablet device, etc.). The power supply interface element 325 may synchronize data related to the mobile communication device 330 with the mobile device.

Accordingly, there are two major connectors on the second wireless apparatus 320, a mobile communication device interface element 326 (e.g. male 30 pin iPhone™ connection) providing power charging and mobile communication device 330 syncing capability located on the inner surface of the device (326) and a power supply interface element 325 (e.g. female Micro USB connection) providing the power charge and mobile communication device 330 synchronization capability located on the bottom of the second wireless apparatus 320. The case 320 may further have a power supply interface element cover 804 that may be moved to cover the power supply interface element 325 to protect the components from damage.

Additionally, the power supply interface element may synchronize data related to the second wireless apparatus 320 to the external device so that an accurate data log of commands, interface data, protocol data, etc. may be analyzed and manipulated in order to test, debug, or otherwise interact with the second wireless apparatus 320.

FIG. 8 shows a back perspective view of an exemplary second wireless apparatus 320 as a case for the iPhone™. The back of the second wireless apparatus 320 may comprise a power transfer switch 802, an input button 803, a power supply interface element cover 804, battery status LED indicators 805, and a stand 806. The second wireless apparatus 320 (e.g. case) may also include an antenna (not shown), piezo alarm (not shown), and a tamper switch (not shown). The stand 806 may include an integrated card slot to provide the user the ability to add a card style kickstand for landscape viewing, or the stand may fold out of the card slot to provide the stand 806.

The power transfer switch 802 controls the transfer of charge between the second wireless apparatus 320 battery (not shown) and the mobile communication device 330. For example, when in an off position, the second wireless apparatus 320 may use the power supply of the mobile communication device 330 to power the second wireless apparatus 320 and the mobile communication device 330 does not receive charge from the battery of the second wireless apparatus 320. However, when in the on position, the rechargeable power supply (e.g. battery) embedded in the second wireless apparatus 320 may be used to charge the battery of the mobile communication device 330 as well as used to operate the second wireless apparatus 320. Furthermore, the power transfer switch may also determine which power supply is charged when an external power supply is electrically coupled through the power supply interface element. Alternatively, in some embodiments, the transfer switch may be ignored when the power supply interface element is engaged with an external power supply.

The second wireless apparatus 320 power supply may have a reserve battery pack (not shown) for the mobile communications device (e.g., iPhone™) as well. The second wireless apparatus 320 may have, for example, a 1500 mAh 3.7V Li-poly cell as its power supply (not shown), which may be charged via the power supply interface element port 325 (e.g., micro-USB port). The battery charger may charge the mobile communications device and the Li-poly cell at a predetermined rate (e.g. 500 mA). The battery charging priority logic may be such that when the power supply interface element is connected to the power source, the mobile communications device may take what it needs and the rechargeable power supply gets the surplus. For example, if the battery charges at a rate of 500 mA, the battery may only charge when the total input current flow is <500 mA. When the power supply interface element is connected to an external device for synchronization, bridge resisters may be swapped in and out according to specifications corresponding to specific mobile communication devices 330 to allow for simultaneous charging and syncing of the mobile communication device 330. Additionally, the battery may keep a predetermined amount of charge if the battery gets low enough so that it is not damaged by running out of battery. For example, the battery may at all times have 15% of its total charge capacity stored within the Li-poly cell to prevent complete run-down and eventual damage to the cell. For example, transfer of power cannot occur if the battery is 15% or lower and any prior battery transfer is stopped once this limit is reached. As described in FIGS. 1 and 2, a small processor, microprocessor, or microcontroller may control the logic for the battery.

Additionally when connected to a charging source using the supplied USB™ to Micro USB™ cable the highest LED of the battery status LED indicators 805 may flash to indicate that the mobile communication device 330 and the second wireless apparatus 320 are being charged. For example, three LEDs illuminated (third LED flashing) on the battery status LED indicators 805 may indicate that the current charge level is between 60% and 80% and the device is charging.

The second wireless apparatus 320 may include an input button 802 to provide several different functions when used in different manners. The battery may have battery status indicators 805 that may be used to show the charging progress and battery charge level. A momentary push button may serve to activate the battery status indicators (e.g. a LED fuel gauge) for a period of time (e.g., 5 seconds) to indicate to the user how much battery power is left in the power supply. The input button may provide other functionality as well. For example, the same input button 802, if held down for a long period of time, may turn the device off by effectively removing the cells from the electronics to preserve power cell shelf life for the second wireless apparatus 320. The input button 802, if pressed when the unit is off, may turn the unit on and indicate to the user the available battery life via the LED fuel gauge. The second wireless apparatus 320 may also automatically turn on (if in the off state) when the mobile communication device 330 is inserted in to the second wireless apparatus 320 (e.g., case). Additionally, in some embodiments, pressing-and-holding the input button for five seconds may toggle the start and halt of the transfer of charge from the rechargeable power supply to the mobile communication device 330.

The battery power LED indicators 805 may be implemented in any suitable fashion to indicate to a user the power level. For example, there may be four power LEDs of the same color that are in-line as shown in FIG. 8. If no LEDs are illuminated, there may be less than 20% charge and thus the battery is close to empty. If one LED is illuminated, there may be between 20-40% charge, two LEDs illuminated may mean 40-60% charge, three LEDs illuminated may mean 60-80% charge, and finally four LEDs illuminated may mean the battery is between an 80-100% charge. Accordingly, the user may easily estimate how much battery remains in the second wireless apparatus 320 power supply and may change their behavior based on the result.

Furthermore, the pattern for the battery power LED indicators 805 on the second wireless apparatus 320 (e.g., case) may vary depending if the rechargeable power supply is charging or if the un-tethered battery level is checked. For example, when an external power supply cable is connected to the power supply interface element port to charge the mobile communication device 330, the power level LED indicators 805 may light up and continue for as long as the battery is charging. Additionally, when a cable is connected, the state of the charge-transfer switch may be ignored. The power supply LED indicators 805 may blink when the power supply interface element (e.g. micro-USB) is connected to the power supply cable, once the mobile communication device 330 is fully charged, and while the rechargeable power supply of the second wireless apparatus 320 charges. Additionally, when the input button 803 is pressed, the power supply LED indicators may light up as to indicate the level of charge built up on the power supply remain lit for a period of time.

The second wireless apparatus 320 and first wireless apparatus may determine the state of charge of the rechargeable power supply through any suitable method. For example, the power levels may be determined using either Coulomb counting or voltage measurement.

Coulomb-counting may offer a continuous estimate of state-of-charge but may also be inaccurate because the method assumes starting from a brand new battery. If the user swaps batteries around and ends up inserting a half-used battery there is no way for the first wireless apparatus 310 to know this and the reckoning may consequently be wrong.

Voltage measurement provides a repeatable method that is unaffected by battery swapping. However, the voltage only substantially changes towards end of life. It may therefore be possible to determine a low-battery warning (after around the 85% point) but it may not be possible to determine a fine-grained state-of-charge continuously throughout the life.

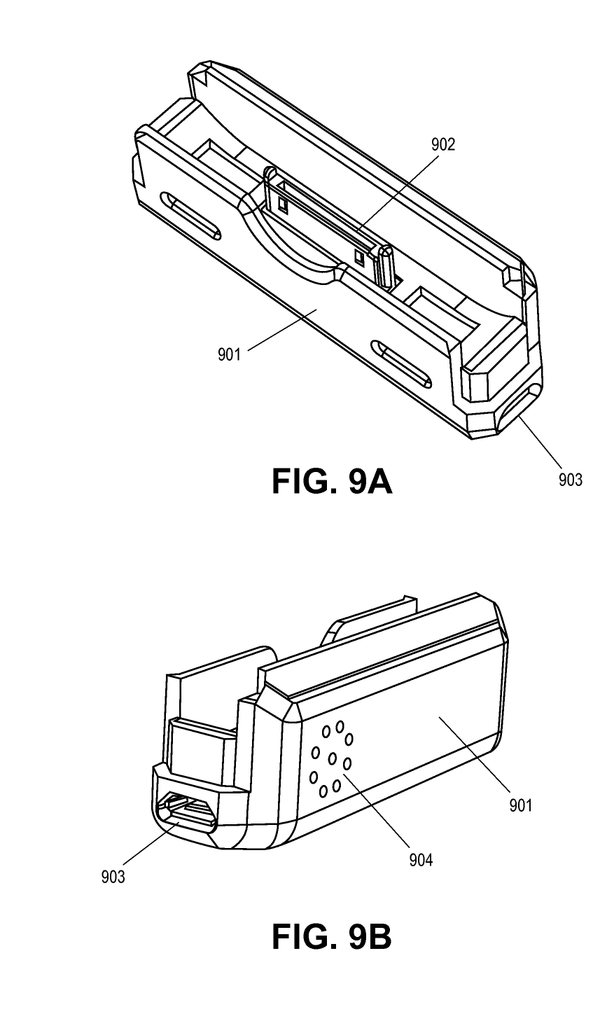

FIGS. 9A-9B show an exemplary embodiment of the second wireless apparatus where the second wireless apparatus 901 is implemented as a dongle. In this embodiment, the second wireless apparatus 901 comprises a dongle that fits on the bottom of a mobile communication device (not shown). The second wireless apparatus 901 comprises a mobile communication device interface element 902 a power supply interface element port 903, and an output component 904 for alerting the user. The second wireless apparatus 901 further comprises an antenna (not shown), a piezo alarm (e.g. vibration engine) for alerting a user (not shown), and a tamper switch (not shown). In contrast to the embodiment shown in FIGS. 7-8, the second wireless apparatus 901 may not comprise a separate power supply for the second wireless apparatus 901. Accordingly, the second wireless apparatus 901 is powered through connection to the power supply of the mobile communication device (not shown) through the mobile communication device interface element 902.

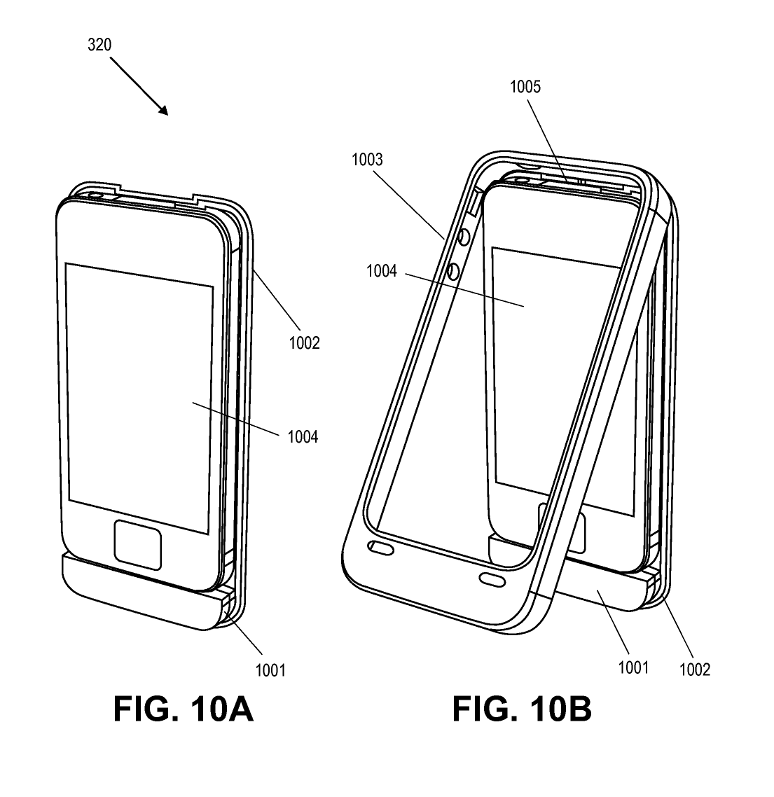

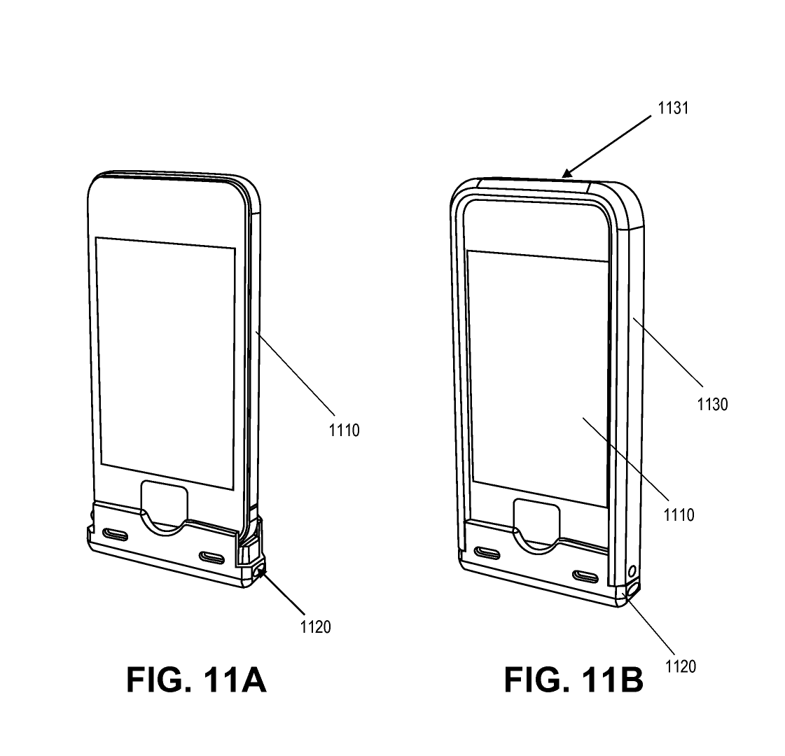

FIGS. 10A-11B show exemplary methods of securing a mobile communication device 1004 to a second wireless apparatus 320. FIGS. 10A-10B show a method of securing a mobile communication device 1004 (e.g. iPhone™) to a second wireless apparatus 320 in the form of a case (as described above in reference to FIGS. 7-8). In one embodiment of the invention, the second wireless apparatus 320 (e.g. case) may be designed to fit snugly or securably surround a mobile communication device 1004 with a clamshell design to provide defense against general wear and tear.

As shown in FIG. 10A, the case 320 may be designed to separate into two portions, a front portion 1003 and a back portion 1002. The back portion 1002 may comprise the mobile communication device interface element 1001. When securing the mobile communication device 1004, first the mobile communication device 1004 (e.g. iPhone™) may be electrically and removably coupled to the back portion 1002 of the second wireless apparatus 320 through the mobile communication device interface element 1001. The back portion 1002 may be designed to fit the form factor of the mobile communication device 1004. Next, the front portion 1003 may be engaged with the back portion 1002 by first engaging the top of the front portion 1003 with the top of the back portion 1002. There may be a hinge, overlapping area, or other engagement device 1005 at the top of the front portion 1003 and back portion 1002 to ensure a correct position when engaged. Next the bottom of the front portion 1003 may be engaged with the bottom of the back portion 1002. The bottom of the front portion 1003 comprises the slider lock, which may snap into place when the front and back portion 1002 are in the correct position. Once engaged, the front portion 1003 and the back portion 1002 will secure the mobile communication device 1004 between them and protect the mobile communication device 1004 from wear, tear, drops, and other damage.

The case may be removed by engaging the slider lock (not shown) and pulling the bottom of the front portion 1003 away from the bottom of the back portion 1002. As explained above in reference to FIGS. 7-8, the slider lock may be designed to impede the separation of the front portion 1003 and the back portion 1002 of the case unless the slider lock (shown in FIGS. 7-8) is moved to the correct position to allow the impediment to clear a path for the separation of the front and back portions 1002, 1003.

FIGS. 11A-11B show a method of securing a mobile communication device 1110 to a second wireless apparatus 1120 in the form of a dongle (as described above in reference to FIGS. 9). First the second wireless apparatus 1120 in the form of a dongle is attached to the mobile communication device 1110. The dongle may be designed to securably surround and engage with the bottom of the mobile communication device 1110. Once secured to the mobile communication device 1110, an outer band 1130 may be attached to the dongle by sliding the outer band 1130 over the mobile communication device 1110. Accordingly, the second wireless apparatus 1120 may be secured to the mobile communication device 1110. The outer band 1130 may be separated from the dongle through any suitable means including pressing on both sides of the outer band 1130 to compress a portion of it so that the bottom portion engaged with the dongle may be physically released, or there may be a disengagement button to unlock the outer band 1130 from the dongle, or any other suitable method to allow the outer portion to be removed from the dongle.

Although not shown in FIGS. 10A-11B, embodiments of the present invention may also comprise one or more tamper switches to implement a physical tamper detection security feature. The physical tamper detection switch (tamper switch) may be incorporated into the second wireless apparatus 320 and can determine when an attempt to remove the mobile communication device 1004 is occurring. The tamper switch may be an electrical switch, an optical sensor, an accelerometer attached to the front or back portion of the case, or any other suitable method of configuring a tamper detection sensor. The tamper switch may be engaged when the mobile communication device is electrically coupled with the second wireless apparatus and may be triggered when the second wireless apparatus is tampered with such that the switch closes or a closed switch opens. When the switch opens (or closes in appropriate embodiments) while the system is armed, a locking command is immediately sent to the mobile communication device such that the mobile communication device is locked and the system enters an alarm condition.

For example, in one embodiment, the tamper switch may be a press switch. A press switch may be configured such that when the upper portion of the case 1003 is coupled to the bottom portion of the case 1002, the top portion of the case 1003 depresses the press switch located on the bottom portion of the case 1002 or the mobile communication device interface element 1001 and engages the tamper detection functionality. If a user removes the top portion of the case 1003, the press switch is released and the second wireless apparatus 320 may issue a locking command through the mobile communication device interface element 1001 to the mobile communication device 1004 before the intruder has an opportunity to separate the phone from the case electronics. The second wireless apparatus 320 may also send an alarm command to the first wireless apparatus 310 to inform or notify the user of the breach. The alarm condition may be removed when the second wireless apparatus 320 is coupled to the mobile communication device 330 again or the first wireless apparatus 310 issues an unlock command to confirm they are aware of the breach.

### II. Exemplary Methods

In embodiments of the invention, the second wireless apparatus and first wireless apparatus exchange messages and acknowledgements at regular intervals of time (e.g., 1.5 seconds) in continuous cycles. The messages may be encrypted and difficult to intercept or tamper. If either wireless apparatus loses contact with the other the first wireless apparatus and/or second wireless apparatus may warn the user by sounding a chirp (i.e. entering a “warning condition”). If wireless communication remains lost for more than a set period of time the first wireless apparatus and/or second wireless apparatus may continue to alert the user by sounding an alarm (i.e. entering an “alarm condition”). The second wireless apparatus may additionally lock the mobile communication device by sending a particular message (i.e. lock command) to the mobile communication device when wireless communication remains lost.

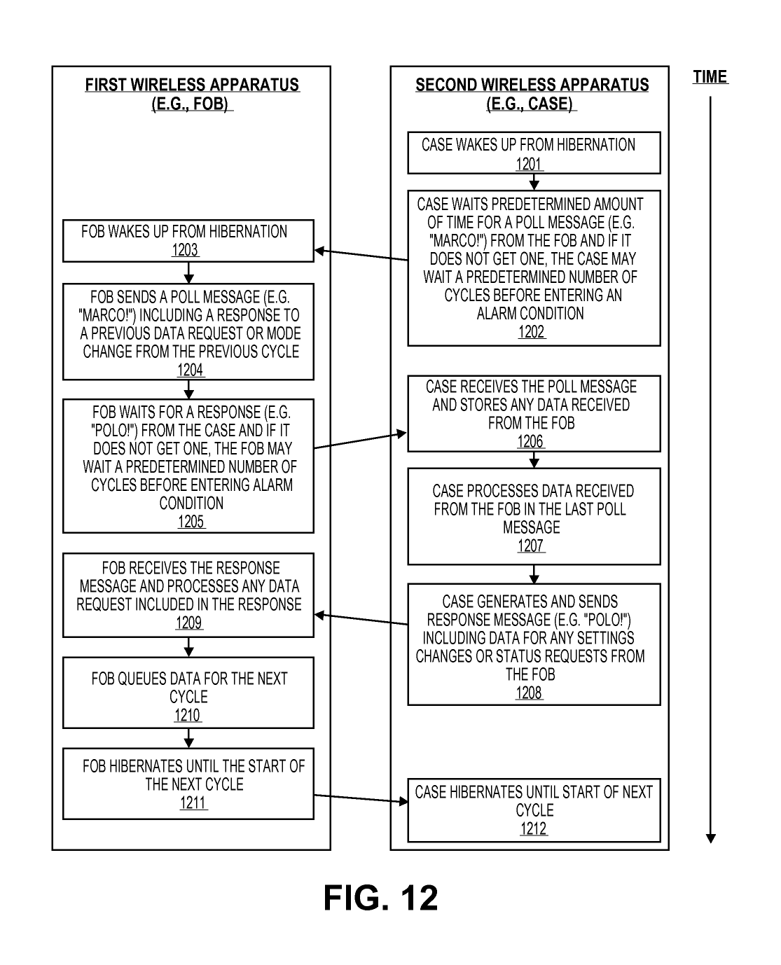

In order to determine whether the first wireless apparatus and the second wireless apparatus are within range or “lose contact” with one another, the first wireless apparatus and the second wireless apparatus periodically communicate with each other to ensure they are still within transmission range. FIG. 12 shows a flow diagram illustrating the first wireless apparatus (e.g., fob) and the second wireless apparatus (e.g., case) data communication and poll-response mechanism. The poll-response mechanism may be initiated by either wireless apparatus although the exemplary embodiment of FIG. 12 shows the second wireless apparatus sending the poll messages and the first wireless apparatus responding to the requests. A poll message may also be called a wireless signal request and the terms may be used interchangeably. A response message may also be called a wireless signal response and the terms may be used interchangeably as well. In the figure, the poll-response mechanism is likened to the game Marco-Polo where a first person yells “Marco!” and in response a second person yells “Polo,” in order to determine where they are located without looking A request message is similar to the Marco message (requesting a response) while the response message is similar to the Polo message which is sent in response to the request.

Although not shown in FIG. 12, prior to the poll-response mechanism beginning, the first and second wireless apparatus may be paired and the connection initialized. The pairing and initialization may occur through any suitable means or method. Typically, at power up, the first wireless apparatus and the second wireless apparatus may send messages out to determine whether any other devices are within communication range that they may pair with.

Initially, when the system is armed, both wireless apparatuses are in hibernation or standby mode and may be waiting for a transmission from either apparatus, as shown in steps 1211 and 1212.

In step 1201, the second wireless apparatus (e.g. case) wakes up from hibernation in order to receive a poll message from the first wireless apparatus (e.g. fob). The case may wake up based on a predetermined cycle which is started after an initialization or pairing of the first and second wireless apparatus occurs.

In step 1202, the case waits a predetermined amount of time for a poll message from the fob. If the case does not receive a poll message during the predetermined wait time, the case may either continue with the sending of the response message, may hibernate until the next cycle, or may actively wait a predetermined number of cycles until the case receives a poll message from the fob. If at the end of the predetermined number of cycles the case still has not received a message, the case may enter an alarm mode as described in further detail below.

In step 1203, the first wireless apparatus (e.g. fob) wakes up from hibernation. The Fob may wake up after the case in time to ensure that the fob does not send a poll message while the case is hibernating. The timing of the steps may be determined at the pairing step such that the timing for both the first and second wireless apparatuses is reset and synchronized.

In step 1204, the fob sends a poll message (e.g. “Marco!”) to the case. The poll message may include a response to the case that was requested in the previous cycle's response message (e.g. providing requested data, respond to a new mode change command that was received from the case, etc.). The poll message may also include any commands or requests that the fob has for the case. For example, if the user presses the “find phone” button on the fob, the next poll message would include a “find phone” command as well as the typical poll message that is expected by the case. The poll message may be complex or simple. It could be as easy an identification message or as complex as an encrypted data message providing a dynamic code depending on the requirements of the system. Either way, the case may know what type of message to expect and will check to ensure that the poll message meets the criteria that are expected before sending a response message.

In step 1205, after sending the poll message, the fob waits for a response from the case for a predetermined amount of time. If the fob does not receive a response from the case, the fob may enter a “warning” mode, transmit another request, and continue sending requests and waiting for a response for a predetermined number of cycles. If the fob does not receive a response message over the predetermined number of cycles, the fob may enter an “alarm” mode, as described in more detail below. As such the fob may be determining whether the second wireless apparatus is within a particular distance from the first wireless apparatus by waiting for a response.

In step 1206, the case receives the poll message and stores any data received from the fob. For example, the case may store the current mode the fob is in (e.g. warning, alarm, etc.), the battery power level of the fob, a command received from the fob (e.g. find phone command, etc.), or any other suitable information including maintenance or performance information.

In step 1207, the case processes the data, including commands or setting changes, received from the fob and may initiate an update to settings or mode for the next cycle. For example, if the poll message included a “find phone” command, the case may process that information, determine a find phone command has been received, and take appropriate action including entering an alert mode to alert the user of the mobile communication device's location. Additionally, the case may determine that a command needs to be sent to the mobile communication device due to the poll message and may generate and send the command to the mobile communication device through the mobile communication device interface element. For example, the case may receive an alarm command from the fob that informs the case that an alarm condition should be entered. After receiving the command, the case may send a lock command to the mobile communication device to ensure that the mobile communication device may not be accessed by a malicious third party as the mobile communication device may be in the act of being stolen.

In step 1208, the case generates and sends a response message (e.g. “Polo!”) to the fob. The response message may comprise data for any settings changes or status requests from the fob or the mobile communication device application. For example, a user may change a setting for the security system using an application running on the mobile communication device. The application may send a command to the case through the mobile communication device interface element to correspond to the data input by the user to change a particular setting. The case may then include the setting change information in the next response message that the case sends to the fob. Accordingly, the system may be synchronized through the use of the same poll-response mechanism that is used to secure the system. Additionally, confirmation messages regarding prior received commands, configuration details, battery supply information, etc. may all be included in the response message sent to the fob.

In step 1209, the fob receives the response message and processes any data included in the response. Similar to step 1206 and 1207 above, the fob may make settings changes or status requests in response to the data received in the response message.

In step 1210, the fob queues data for the next cycle so that it may wake from hibernation and send the poll or request message immediately. The fob queues the data for the next cycle by determining what requests, commands, or updates are needed from the case and processing the appropriate data to ensure a successful cycle in the next round of communication.

In step 1211, the fob hibernates until the start of the next cycle. As explained previously, the fob may wait a predetermined amount of time for the next cycle and the timing may be set at the time of synchronizing or pairing with the case. In step 1212, similar to step 1211, the case hibernates and waits for the next cycle to begin to continue the process. The order of the hibernation may be interchangeable and is provided in this manner merely as an example.

Although the above described exemplary poll-response mechanism had the first wireless apparatus sending wireless request messages and the second wireless apparatus sending wireless response messages, either apparatus could send either the poll (wireless request message) or the response (wireless response message) during the poll-response mechanism. Accordingly, a second wireless apparatus may send a wireless request message to the first wireless apparatus, determine whether the second wireless apparatus is within a particular distance from the first wireless apparatus, wherein determining whether the second wireless apparatus is within a particular distance from the first wireless apparatus comprises waiting a predetermine period of time to receive a response message from the first wireless apparatus and if no response message is received by the second wireless apparatus during the predetermined period of time, determining the that the second wireless apparatus is not within the particular distance from the first wireless apparatus and locking the mobile communication device from use. The method may further comprise receiving a wireless signal response from the first wireless apparatus if it is within the particular distance and storing data contained in the wireless signal response received from the first wireless apparatus as well as communicating with the mobile communication device. Furthermore, the particular distance may be a transmission range of the first transceiver and the second transceiver. Additionally, the first wireless apparatus may alert the user if the second wireless apparatus is not within the particular distance from the first wireless apparatus. These method steps may also be performed through the second wireless apparatus sending a wireless response message in response to the wireless request message sent by the first wireless apparatus.

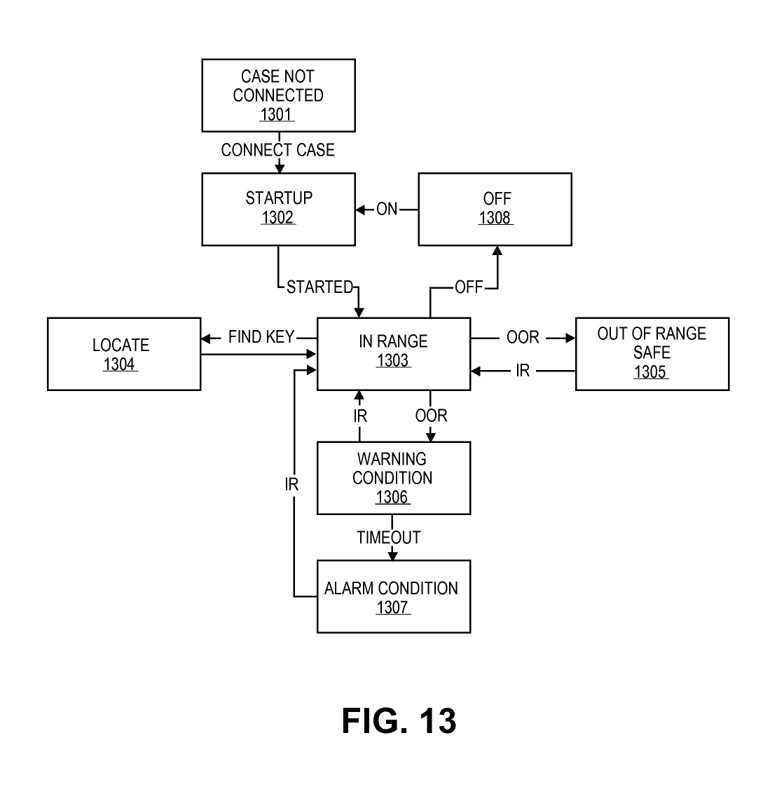

FIG. 13 illustrates the different hardware states that the second wireless apparatus may enter in relation to the first wireless apparatus according to embodiments of the present invention. In the exemplary embodiment shown in FIG. 13, the second wireless apparatus is a case but it could also be a dongle or other embodiment as described herein.

First, when the case is not connected to the mobile communication device the second wireless apparatus (e.g. case) is in a case not connected state 1301.

Once the case is connected to the mobile communication device, the second wireless apparatus enters a startup state 1302. The case may be configured to automatically enter the startup state 1302 when electrically coupled to the mobile communication device or the case may be designed such that it will only enter the startup state once the case is powered on or the case is activated using the application on the mobile communication device. The startup state comprises initialization and pairing activities where the second wireless apparatus and the first wireless apparatus exchange communication messages to determine if a corresponding device is within transmission range, is available to be paired, and is not already paired with another device (unless in multiple pairing mode).

Once paired, initialized, and the startup state is completed, the case may find the key it has been paired with by receiving a poll message or sending a poll message to start the poll-response mechanism described above in regards to FIG. 12.

If the key receives the polling message and sends a response or if the case receives a polling message from the key, the case is in an in-range state. The in-range state informs the case that a paired key is within the predetermined range and as such, no warning condition 1306 or alarm condition 1307 is entered. However, if the second wireless apparatus stops receiving a polling message or a response message (depending on the configuration of the system), the case determines that the first wireless apparatus is out of range (“OOR”) and the case may enter one of three different states.

If the second wireless apparatus has entered a disarmed, bypassed, or other safe or deactivated mode, the second wireless apparatus may enter an out of range safe 1305 state. The out of range safe 1305 state is entered when the key and the case are out of range and thus would be entering an alarm condition 1307 or warning condition 1306 if armed. However, there may be times when the user wants to limit the alarm functionality or knows that they will be away from their mobile communication device and would like to be able to be separated without an alarm condition 1307 or warning condition 1306 being entered. For example, this state may be entered when the system is disarmed through the application running on the mobile communication device, when the mute button has been engaged on the first wireless apparatus prior to a loss of contact, or any other suitable programmed deactivated or safe state.

However, if the second wireless apparatus is not in a safe state, and the first wireless apparatus moves out of range of the second wireless apparatus, the second wireless apparatus may enter a warning condition 1306. The warning condition 1306 is entered when the second wireless apparatus first determines that the first wireless apparatus 1306 is out of range (00R). The second wireless apparatus and the first wireless apparatus may notify the user using feedback devices (e.g. sonic, haptic, etc.) if the first wireless apparatus or the second wireless apparatus fail to receive proper responses or requests for a set period of time or a set number of attempts.

If the warning condition 1306 persists for a set period of time (e.g. a timeout period), the feedback may change (e.g. a different sound, a louder sound, etc.) for both wireless apparatuses and the second wireless apparatus may enter an “alarm condition” 1307. The timeout period may be determined using the cycles of the poll-response mechanism or through any other suitable timing mechanism. The alarm condition 1307 may result in the second wireless apparatus sending a locking command to the mobile communication device in order to protect the mobile communication device from unauthorized access or use of the mobile communication device. In some embodiments of the invention, it may be desirable that the alarms for the second wireless apparatus and first wireless apparatus be independently disabled while the locking functionality remains intact.

Although not shown in FIG. 13, in some embodiments, the alarm condition 1307 may also be entered if the mobile communication device is removed (or attempted to be removed) from the second wireless apparatus while the system is active or armed. The system may implement a physical tamper detection switch (“tamper switch”) that is incorporated into the second wireless apparatus and can determine when an attempt to remove the mobile communication device is occurring. The tamper switch may be triggered if the second wireless apparatus is opened or decoupled from the mobile communication device while the second wireless apparatus is in an armed state. The tamper switch may be an electrical switch, an optical sensor, an accelerometer attached to the front or back portion of the case, or any other suitable method of configuring a tamper detection sensor. The tamper switch may be engaged when the mobile communication device is electrically coupled with the second wireless apparatus and may be triggered when the second wireless apparatus is tampered with such that an open tamper switch closes or a closed tamper switch opens. When the switch opens (or closes in appropriate embodiments) while the system is armed, a locking command is immediately sent to the mobile communication device such that the mobile communication device is locked and the system enters an alarm condition 1307. The alarm condition 1307 may be removed when the second wireless apparatus is coupled to the mobile communication device again. Once the second wireless apparatus determines that the tamper switch is triggered, the second wireless apparatus may transmit a wireless signal response or a wireless signal request to the first wireless apparatus including an indication that the tamper switch is triggered. The first wireless apparatus may then enter an alarm condition and alert the user in response to receiving the indication that the tamper switch is triggered.

Both the warning condition 1306 and the alarm condition 1307 may be cleared automatically when the wireless apparatuses come within a particular distance of each other again (i.e. are in range (“IR”)). Both the warning condition 1306 and the alarm condition 1307 may cause the second wireless apparatus to send a wireless request message or a wireless response message to the first wireless apparatus including an indication of the condition of the system. The alarms may also be silenced by pressing a specific input button (i.e. Mute button) on the first wireless apparatus which may stop the alerts but may not necessarily change the state of the hardware.

Finally, the second wireless apparatus may enter a “locate” 1304 state when the second wireless apparatus receives a “find key” command from the user by the pressing of a find key button on the second wireless apparatus. The locate 1304 state may also be entered through a command from an application running on a mobile communication device in embodiments implementing an application. The locate 1304 state maximizes the transmission range of the second wireless apparatus if the ranges have been programmed to a close range state through the application (as explained in more detail below). The locate 1304 state causes the second wireless apparatus to send a “find key” command to the first wireless apparatus in the next wireless request message or wireless response message sent as part of the poll-response mechanism. The first wireless apparatus may receive the “find key” command and may alert a user as to the location of the first wireless apparatus through any of the output components the first wireless apparatus comprises (e.g. making noise, flashing lights, vibrating, etc.). The first wireless apparatus may stop notifying the user when the user presses a mute button or the notifications may time out after a period of time. Additionally, the second wireless apparatus may only be in the locate 1304 state for a momentary or transitory period of time between when receiving the command to the find the key and when the find key command is sent to the first wireless apparatus. As such, the second wireless apparatus may return to the in range 1303 state once the find key command has been sent as part of the poll-response mechanism. Additionally, in some embodiments, the locate 1304 state may not be exited until the second wireless apparatus receives a confirmation that the first wireless apparatus received the find key command in the next poll-response mechanism message received. Additionally, second wireless apparatus may maintain the locate 1304 state until the second wireless apparatus receives confirmation that the first wireless apparatus has been muted by the user engaging a mute button and thus that the first wireless apparatus has been found.

### III. Exemplary Embodiments Implementing an Application

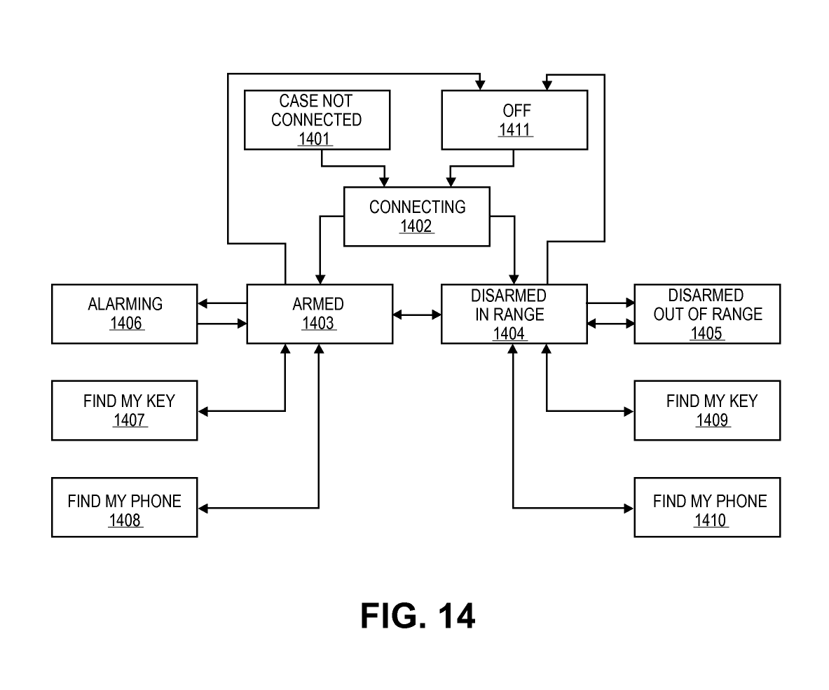

FIG. 14 shows a user state diagram illustrating the different modes of operation and the state flow diagram of each user state according to embodiments of the invention. The user state diagram roughly corresponds with the hardware state diagram but includes both an armed and disarmed user state functionality that may be implemented using the application running on the mobile communication device.

In embodiments of the present invention, there may be different modes of operation for the security system. The different operational modes may include Armed, Disarmed, Suspended, Find Key (e.g., first wireless apparatus), Find Phone (attached to second wireless apparatus), and Mute. The different operational modes can be configured and set by a user through the use of an application running on the mobile communication device.

The system operates in an armed operational mode (corresponding to armed state 1403 in FIG. 14) if the system is initialized, paired, and actively communicating through the poll-response mechanism described in reference to FIG. 12. In an armed mode, if the system determines that the second wireless apparatus and first wireless apparatus are separated beyond a defined range the first wireless apparatus may provide an audible and vibratory notification to the user (corresponding to alarming state 1406 in FIG. 14). Additionally, the second wireless apparatus may make an audible, vibratory, or visual notification that is alarming as well. If the second wireless apparatus and first wireless apparatus are brought back within range after the alarm has initiated, the first wireless apparatus and/or second wireless apparatus notifications may stop. Additionally, if the second wireless apparatus is breached (i.e., removed or tampered with) while in an armed mode an integrated tamper switch may trigger the first wireless apparatus to provide an audible and vibratory notification to the user (i.e. enter an alarming state).

The system operates in a disarmed operational mode if the system is initialized, paired, and actively communicating with the poll-response mechanism but the user has either not armed the system or the user has previously de-activated the system through the application running on the mobile communication device. When the system is in a disarmed operational mode, all audible, vibratory, and visual notifications in the first wireless apparatus may be disabled and may not sound. Transceivers in the wireless apparatuses may remain active so that the second wireless apparatus and the first wireless apparatus may still communicate when in range of each other, however no notifications may be made to the user and no alarm condition may be entered.

The system operates in a suspended operational mode if the first wireless apparatus and the second wireless apparatus are placed into low power states through the application running on the mobile communication device or through a physical input button on the first wireless apparatus or the second wireless apparatus. Wireless transceiver communications may be disabled as required for airline travel, and both the second wireless apparatus and first wireless apparatus may re-activate to re-initiate the wireless communication with each other. The suspended operational mode may be configured to comply with Federal Aviation Administration (FAA) regulations, in which all devices broadcasting radio waves may be disabled upon boarding of planes as well as with institutions that have sensitive equipment (e.g. medical facilities). The suspended operational mode may disable the radios on the first wireless apparatus and the second wireless apparatus and put the electronics into a deep-suspended/power-saving mode. Suspended operational mode may be independent on the first wireless apparatus and the second wireless apparatus.

When powered down due to loss of power or entering of a suspended operational mode, the wireless apparatuses may need to be re-started once re-connection is desired. Powering or starting up methods for the second wireless apparatus may include plugging into the mobile communications device, initiating automatic powering up when it is connected to the mobile communications device (e.g. iPhone™). The second wireless apparatus may also be re-enabled via the application to wake it up from Suspend Mode. For the first wireless apparatus, the user may press and hold the buttons in combination to wake it up. The first wireless apparatus may indicate successful wake-up by flashing an alternating pattern on the LEDs for a period of time (e.g., 2 seconds).

The system operates in a find key operational mode (corresponding to 1407 and 1409 in FIG. 14) if the system is commanded to enter the find key operational mode by a data input from a user in the application running on the mobile communication device or through a physical input button on the second wireless apparatus. The find key operational mode is entered by the second wireless apparatus communicating the find key command with the first wireless apparatus (e.g. a key). The find key command may cause the key to make an audible, vibratory, or visual notification for a period of time (e.g., 15 seconds) provided the second wireless apparatus and first wireless apparatus are in range. The first wireless apparatus may send a confirmation message as part of the next poll-response mechanism message to the second wireless apparatus to inform the second wireless apparatus that the key is still in range and has entered the find key operational mode. A mute button on the first wireless apparatus may be provided to silence the notification at any time. If the first wireless apparatus is not in range, the second wireless apparatus may continue trying to contact the first wireless apparatus for a period of time or until a response is received from the first wireless apparatus. Additionally, if the second wireless apparatus is in a low range setting for transmission range, the transmission range should be changed back to full power in order to provide the best chance of contacting the first wireless apparatus.

The system operates in a find phone operational mode (shown as 1408 and 1410 in FIG. 14) if the system is commanded to enter the find phone operational mode by a user input of the “find phone” input button on the first wireless apparatus. The user may activate the find phone operational mode through the first wireless apparatus (e.g. pressing a button on the first wireless apparatus, voice command, etc.) and the first wireless apparatus may communicate with the second wireless apparatus attached to the mobile communication device (e.g., phone) to cause the second wireless apparatus to cause an audible, vibratory, or visual notification. The second wireless apparatus may sound for a period of time (e.g., 15 seconds) or cause any other notification to occur using the output components of the second wireless apparatus or the mobile communication device provided the second wireless apparatus and first wireless apparatus are in range. If the second wireless apparatus are not within range, the first wireless apparatus may continue to send a find phone command as part of the poll-response mechanism or may send a separate find phone command message for a period of time or until the second wireless apparatus responds with a confirmation message.

The system operates in a mute operational mode (not shown) if the system is configured for a mute setting using the application running on the mobile communication device. The mute setting may be input by a user using the application running on the mobile communication device which then communicates with the mobile communication device through the mobile communication device interface element to change the settings of the second wireless apparatus. The second wireless apparatus may then communicate the mute operational mode setting to the first wireless apparatus during the next poll-response communication. When the system is in “Mute” operational mode, all audible notifications within the first or second wireless apparatus are muted, but visual notifications may remain active.

Returning to FIG. 14, the user state diagrams show some of the operational modes described above and the state flow diagram of each user state according to embodiments of the invention.

When a second wireless apparatus has not been connected, the system is in a case not connected state 1401. The system will not operate when in a case not connected state 1401 and if a first wireless apparatus or a second wireless apparatus is powered on without the second wireless apparatus being connected to the mobile communication device, the apparatuses may enter a suspended or low power state and wait for an indication that the second wireless apparatus has electrically coupled with a mobile communication device. Once the second wireless apparatus is electrically coupled to a mobile communication device, the system may move to a connecting state 1402.

Once the second wireless apparatus is connected to the mobile communication device, a connecting state 1402 is entered. The connecting state 1402 is entered during startup and power-up of the first and second wireless apparatus and corresponds to the “Startup” state 1301 described above in reference to FIG. 13. The connecting state 1402 may be automatically entered once a mobile communication device is coupled to the second wireless apparatus. The connecting state 1402 includes the initialization of the second wireless apparatus, the pairing of the second wireless apparatus with a first wireless apparatus within range of the second wireless apparatus, the initialization of the first wireless apparatus, any required communication with the mobile communication device, and the loading of configuration settings for each wireless apparatus. The connecting state 1402 may also comprise or be interchangeable with the synchronization of the second wireless apparatus, the first wireless apparatus, and the mobile communication device.

An armed state 1403 or a disarmed state 1404 may be entered once the system is connected depending on the default configuration of the system. In some embodiments, the system may be designed to default to an armed state 1403 once the system is connected and synchronized, while other embodiments may be designed to enter a disarmed state 1404 until the user arms the security system.

An armed state 1403 is entered when the system is in an armed state 1403 and the first wireless apparatus is within range of the second wireless apparatus. When the system is in the armed state 1403, the system may be considered to be in a secured state because the system will shift to an alarming state 1406 and notify a user of any physical disturbance to the second wireless apparatus or loss of communication with the first wireless apparatus.

An alarming state 1406 may be entered when the system is in an armed state 1403 and the first and the second wireless apparatus are out of range. Additionally, the alarming state 1406 may be entered if a tamper switch on the second wireless apparatus is triggered. The tamper switch may be triggered if the second wireless apparatus is attempted to be removed from the mobile communication device while the system is in an armed operational mode or the second wireless apparatus is otherwise physically tampered with while in an armed operational mode. The alarming state 1406 comprises both the “warning condition” 1306 and “alarm condition” 1307 hardware states of FIG. 13.

There are two separate disarmed states: disarmed in range state 1404 and disarmed out of range state 1405. A disarmed in range state 1404 is entered when the system is in a disarmed operational mode and the first wireless apparatus is in range of the second wireless apparatus. The disarmed in range state 1404 corresponds to the in range hardware state 1303 when in the disarmed operational mode described above.

A disarmed out of range state 1405 is entered when the system is in a disarmed operational mode and the first wireless apparatus and the second wireless apparatus are not within range of each other. The disarmed out of range state 1405 corresponds to the out of range safe 1305 state described in reference to the hardware state diagram of FIG. 13.

A find my phone state 1408 and 1410 may be entered when the system receives a find my phone command from the first wireless apparatus as a result of a data input by a user on the first wireless apparatus. The find my phone states are shown in 1408 and 1410 for when the system is in armed operational mode and disarmed operational mode, respectively. As shown FIG. 14, the find my phone state may be entered from either the armed state or the disarmed state, and the operational mode may be very similar whether entered from the armed state or disarmed state.

A find my key state 1407, 1409 may be entered when the system receives a find my key command from the application connected through the mobile communication device interface module of the second wireless apparatus. The second wireless apparatus may in turn send a find my key command to the first wireless apparatus which instructs the first wireless apparatus to notify the user of its location by vibrating, making an audible sound, or flashing lights or other visual notifications. In some embodiments, the find my key states 1407 and 1409 may be a one-time issue of a command to the first wireless apparatus to sound a speaker and may not create a state change. However, the user interface of the application running on the mobile communication device may present this as an animation to inform the user that the find my key functionality has been initiated and the system is attempting to contact the key. The find my key state may correspond to the locate 1304 state described above regarding FIG. 13.

Although not shown in FIG. 14, additional states may be integrated into the application running on the mobile communication device in accordance with other embodiments of the invention and are described below.

A finding state may be entered when the first wireless apparatus initiates the find my phone functionality and sends a find my phone command to the second wireless apparatus, which may be sounding. The user interface may display a notification that the first wireless apparatus has initiated a find my phone command and the display may remain along with the sound output, until the user initiates another find my phone command on the first wireless apparatus or the user enters a password on the mobile communication device, or an input button is pressed on the second wireless apparatus confirming that the mobile communication device has been found.

A first wireless apparatus out of range state may be entered when the second wireless apparatus cannot communicate with the first wireless apparatus and the system is in a disarmed operation state or has not yet powered up and synchronized with the first wireless apparatus (see “Start Up” 401 or “Connecting” 801 in FIGS. 4 and 5, respectively). The ability to change any settings to the system may be inactive in the application when in this state and this may state may be changed once the second wireless apparatus synchronizes or is paired with a first wireless apparatus.

An ok state may be entered when the second wireless apparatus can communicate with the first wireless apparatus and is not in the finding state. The ability to change any settings to the system may be inactive in the application when in this state.

An inactive state may be entered when the second wireless apparatus is attached to the mobile communication device, but the second wireless apparatus is in the suspended operational mode described above (i.e. in a low-power mode). With the exception of turning off suspended mode, the ability to change any settings to the system may be inactive in the application when in this state.

A not present state may be entered when the second wireless apparatus is not attached to the mobile communications device, and may be a software or application state only (i.e. the state does not correspond to a hardware state). The ability to change any settings to the system may be inactive in the application when in this state until a second wireless apparatus is connected to the mobile communication device.

### Exemplary Embodiments of the Application

As described previously, in some embodiments of the invention, the system may have a software component installed on the protected device (e.g. mobile communication device), such as an application. The user interface of the software provides controls over the system's behaviors and allows a user to customize the system to maximize its effectiveness. For instance, the range or particular distance that the first wireless apparatus and the second wireless apparatus are configured to transmit messages as part of the poll-response mechanism, the definitions of alarm conditions, and the system's responses to alarm conditions may be defined and configured by the user using the application running on the mobile communication device.

FIG. 3 shows an exemplary embodiment of a security system 300 according to embodiments of the invention including an application 340 running on the mobile communication device 330. The security system comprises a first wireless apparatus 310 and a second wireless apparatus 320. A mobile communication device 330 is secured into a second wireless apparatus 320 in the form of a case, and an application 340 is downloaded onto the mobile communication device 330 (e.g. iPhone™).

The mobile communication device comprises a third processor and a third computer readable medium coupled to the third processor and comprising code executable by the third processor to implement an application. The application may synchronize the mobile communication device and the second wireless apparatus through the mobile communication device interface element, receive a data input from a user, and update the second wireless apparatus with information corresponding to the data input. The data input may correspond to configuration information for the first wireless apparatus and/or the second wireless apparatus of the security system. The second wireless apparatus may subsequently wirelessly update the first wireless apparatus with the configuration information corresponding to the data input.

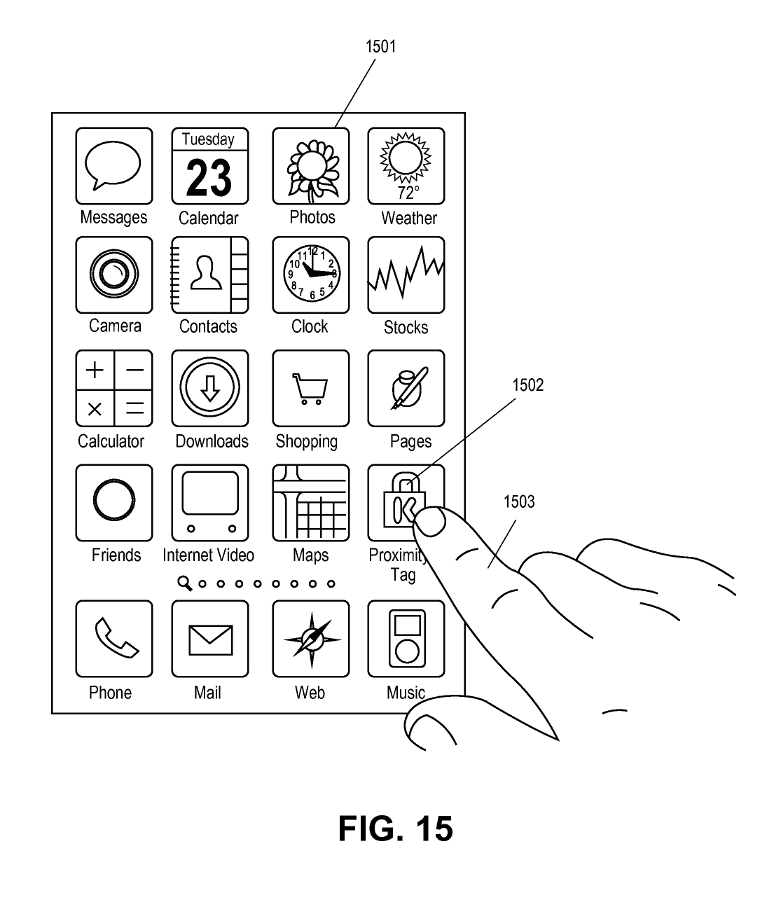

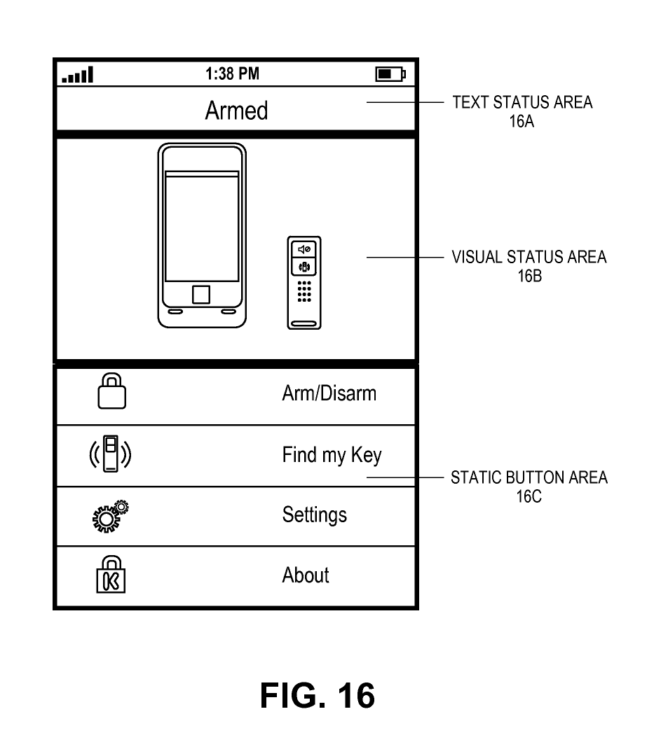

As an example of an application 340 for a mobile communications device 330, an exemplary iPhone™ application 340 in accordance with embodiments of the invention is described below. FIGS. 15-25 show exemplary screen shots of an exemplary application for the iPhone™ mobile communication device shown in FIG. 3. FIG. 15 shows an exemplary screenshot of the display 1501 of the mobile communication device (e.g. iPhone™) after the application 1502 has been downloaded and shows a user 1503 launching the application by tapping on the application icon 1502. FIG. 16 shows an exemplary screenshot after the application has been launched. The application display may include a text status area 16A, a visual status area 16B, and a static button area 16C.

Once launched, the application 340 may identify the presence, synchronize, and communicate with the second wireless apparatus through electrical communications between the mobile communication device and the second wireless apparatus through the mobile communication device interface element. After successfully connecting to the hardware, the application may communicate with the hardware via a pre-defined protocol.

The following section describes the coordination and communication of information between the mobile communication device application and the hardware, and the display of information to the user. The table specifies the conditions that may be present for the application to be in each state. The application may monitor the set of conditions on a periodic basis and may automatically enter the appropriate state when a condition change is detected. As such, user input may cause the application to perform different functions by changing the conditions that determine the current state of the application. Table 1 shows an exemplary application state table where the functionality and state of the application is determined by conditions of the application.

TABLE 1
Application State Table:

| | Second | | | | | |
|---|---|---|---|---|---|---|
| | wireless | | | | | |
| | apparatus | Suspend | Armed/ | In/Out | | FOB |
| Name | connected | Mode | Disarmed | Range | Alarming | Battery |
| Second wireless apparatus | NO | x | x | x | x | x |
| not connected | | | | | | |
| Suspend Mode | YES | YES | x | x | x | x |
| Disarmed | YES | NO | DISARMED | IN | x | OK |
| Disarmed, Battery Low | YES | NO | DISARMED | IN | x | LOW |
| Armed | YES | NO | ARMED | IN | NO | OK |
| Armed, Battery Low | YES | NO | ARMED | IN | NO | LOW |
| Alarming | YES | NO | ARMED | OUT | YES | x |

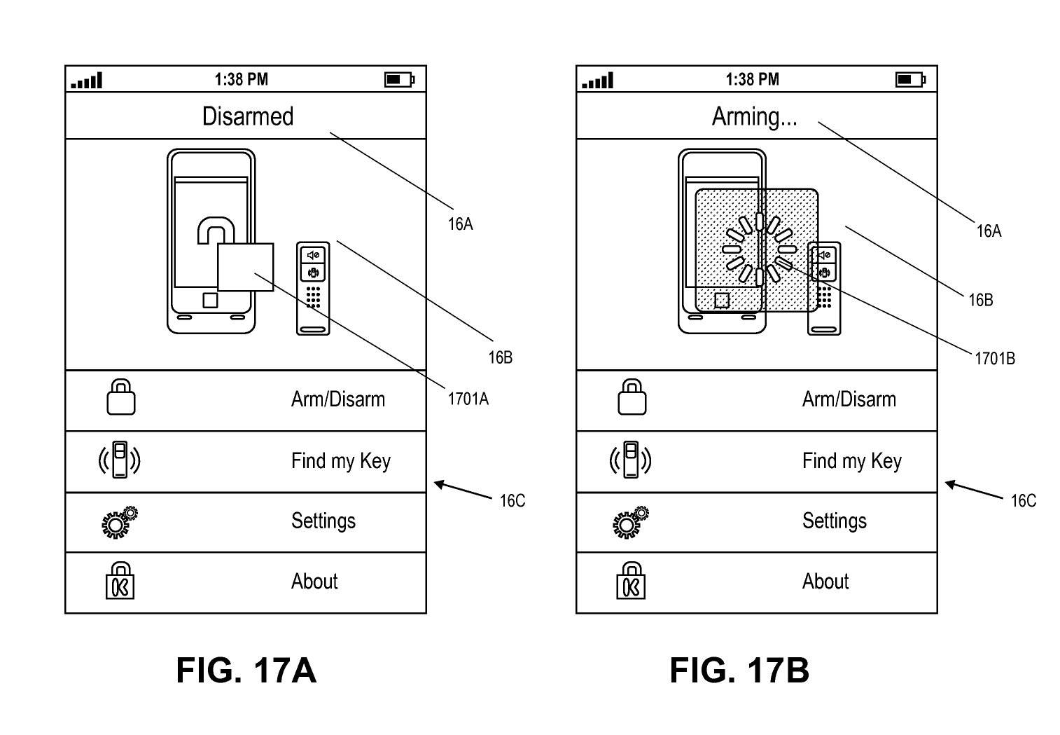

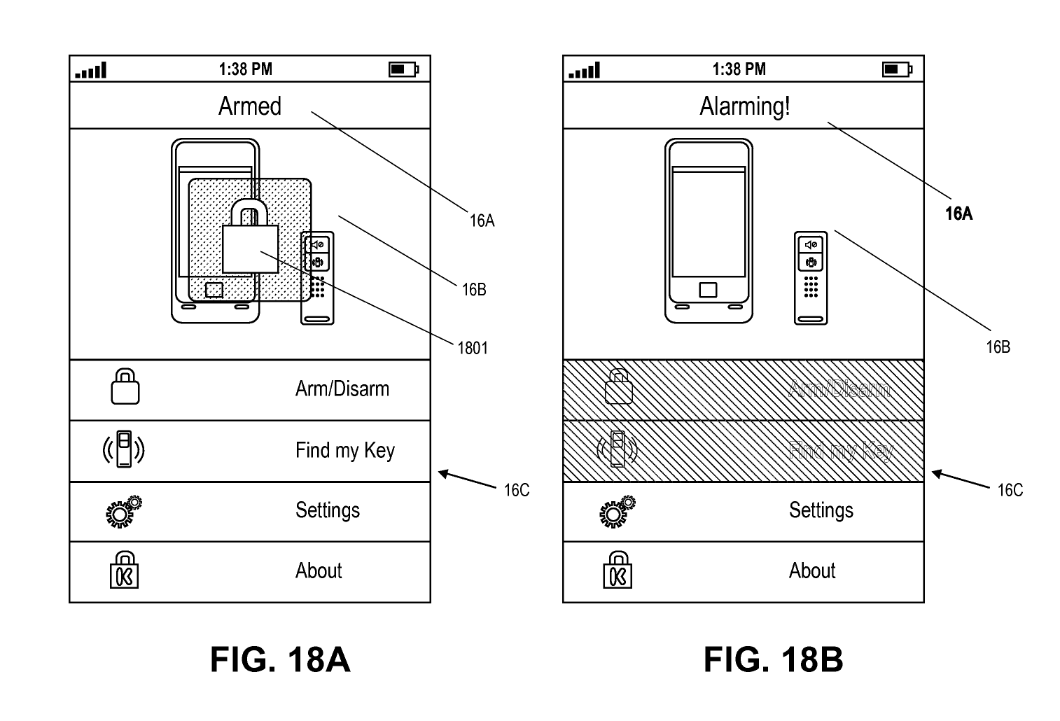

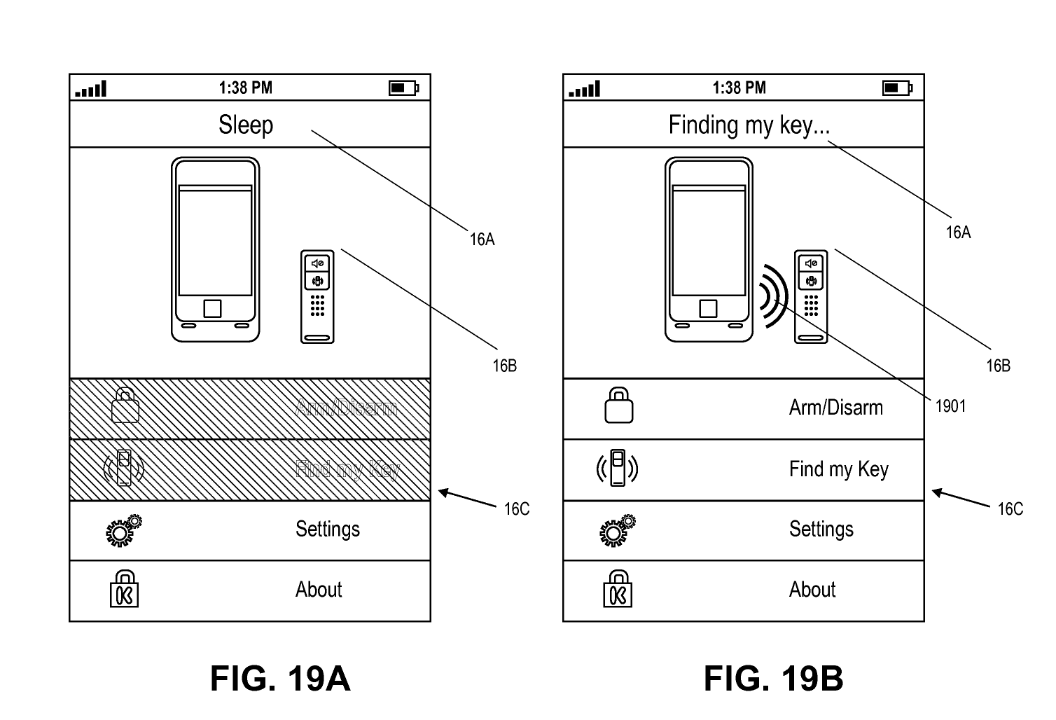

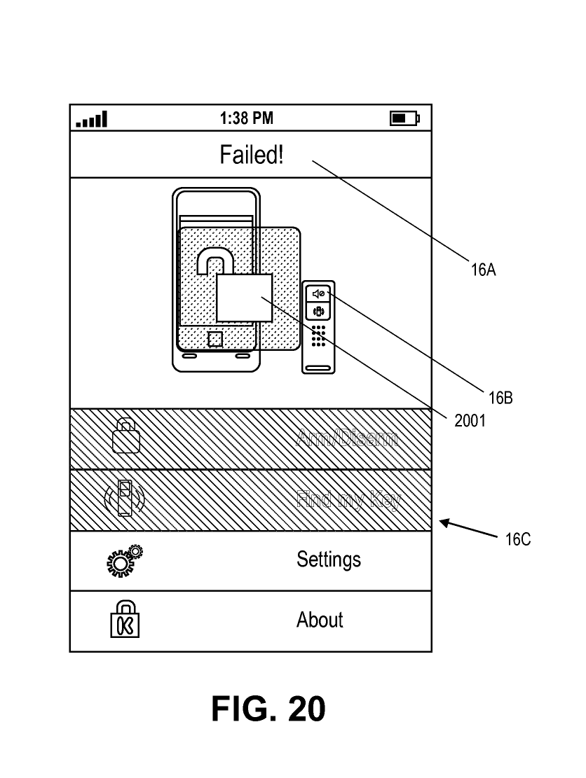

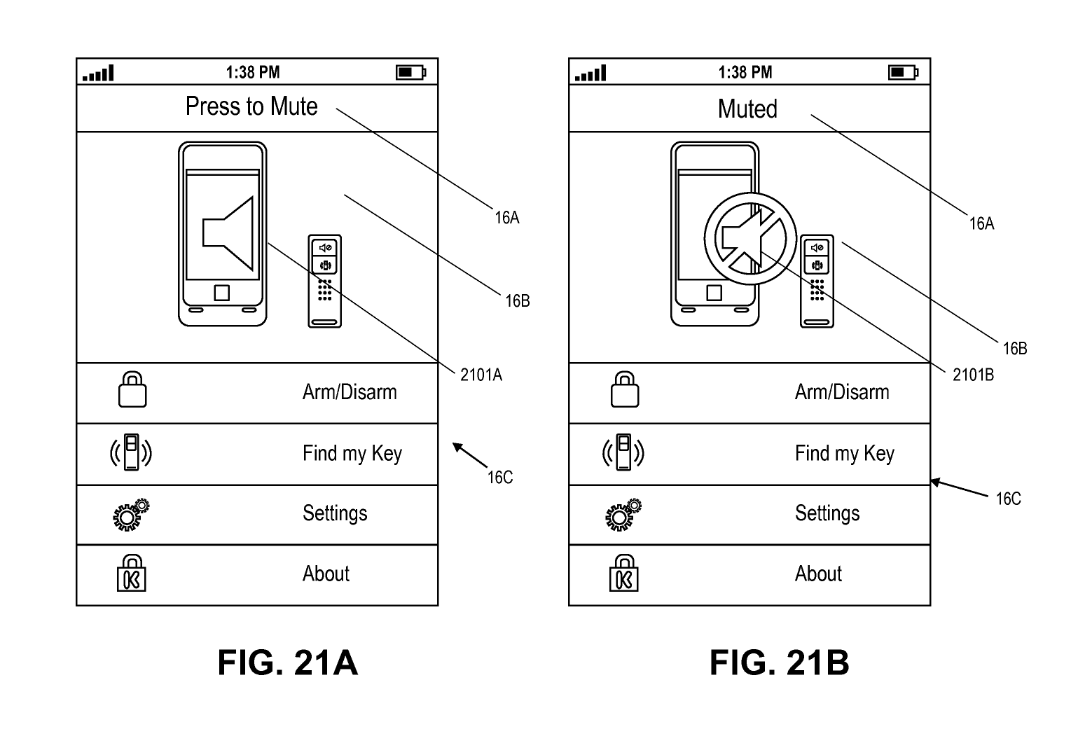

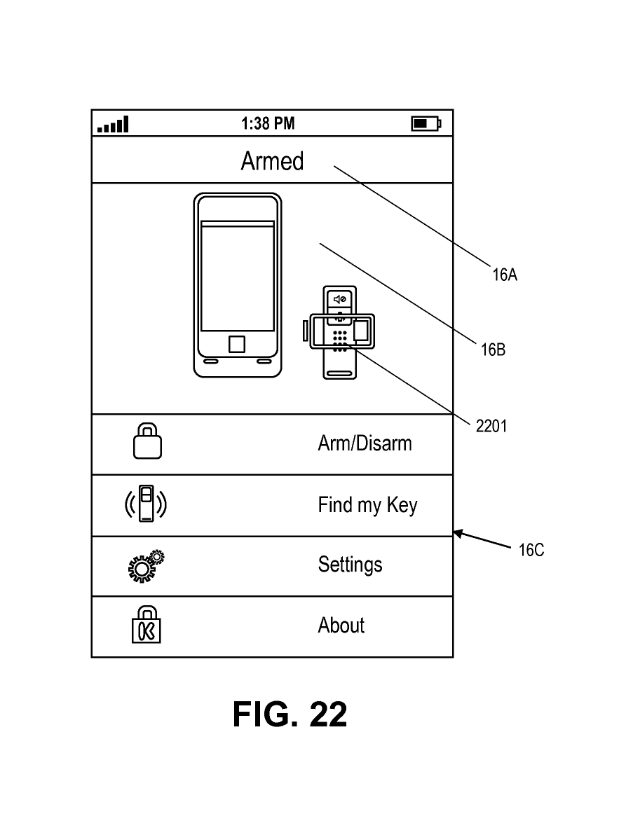

FIGS. 17-24 shows exemplary screenshots of an application while performing different functions in different operating modes. FIGS. 17A, 17B, 18A, and 18B show exemplary screenshots of the application when the system is in the disarmed, arming, armed, and alarming operational modes, respectively. FIG. 19A shows an exemplary screenshot of the application during a sleep or suspended operational mode, FIG. 19B shows an exemplary screenshot of the application in a find my key operational mode, FIG. 20 shows an exemplary screenshot of the application after a failed attempt to enter an armed operational mode, FIGS. 21A and 21B show exemplary screenshots of the application performing the mute function during an alarming operational mode, and FIG. 22 shows an exemplary screenshot of the application during an armed operational mode when the power supply of the second wireless apparatus is low. These modes have been described above and are described in further detail below.

FIGS. 17A, 17B, 18A, and 18B show exemplary screenshots of the application when the system is in the disarmed, arming, armed, and alarming operational modes, respectively. In FIG. 17A, the system is in a disarmed operation mode. The text status area 16A may display “disarmed” message and the visual status area 16B may show a lock icon in an unlocked configuration 1701A that alerts a user to the disarmed and unsecured status of the security system immediately upon sight. Additionally, the static button area 16C may be fully engaged such that the user may have the ability to arm the system, find the key, configure the settings as desired, or determine more information about the system.

When the user taps on the Arm/Disarm menu item, the application may perform a round-trip command to arm the system and may confirm successful completion of the armed operation. A round-trip command process includes the application sending a command to the second wireless apparatus to enter an armed mode. The second wireless apparatus receives the command through the mobile communication device interface element, processes the command and enters an armed mode, and generates a data message to include in the next poll-response message to the first wireless apparatus in order to update the first wireless apparatus with the armed command. The second wireless apparatus then waits to receive confirmation from the first wireless apparatus the next poll-response mechanism message received from the first wireless apparatus. If the second wireless apparatus receives confirmation, the second wireless apparatus sends a confirmation message to the mobile communication device and the round-trip command processing is completed. If the second wireless apparatus does not receive a response from the first wireless apparatus that includes a confirmation message, the second wireless apparatus may retry the setting message for a set number of attempts or may send a failure message to the mobile application. The result of an armed command that could not be completed is shown in FIG. 20. The failure message informs a user that the system is not armed and in some embodiments may explain why the system could not be armed. For example, “first wireless apparatus is out of range” or “no first wireless apparatus found” could be displayed to the user.

While the system is processing the armed command, the screen may show a working graphic 1701B in the visual status area 16A and the text status area may display the status of “arming.” If the round-trip command is successful, the application may enter the armed state as shown in FIG. 18A. When entering this state from the initializing state, disarmed state, or at the start-up of the application, the application may display a momentary overlay with a “closed lock” 1801 icon to highlight the secured state of the system.

The application is in the alarming state if the hardware is in a warning condition or alarm condition. As described above in reference to FIG. 13, the warning condition 1306 and alarm condition 1307 are entered if the first wireless apparatus and the second wireless apparatus are separated while in the armed mode or if the mobile communication device is attempted to be removed from the second wireless apparatus while in an armed operational mode. If the alarm condition is maintained for a predetermined amount of time without the first wireless apparatus being brought back into range, the mobile communication device may be locked and the alarming screenshot may or may not be shown when in a locked configuration. The text status area 16A may display an “alarming!” message and the visual status area 16B may show a red flashing light that alerts a user to the alarming condition upon sight. Additionally, the static button area 16C may disable the find my key and arm/disarm buttons so that if the mobile communication device is being taken, a malicious party cannot change the settings and disable the security features. The settings may be disabled or limited as well to ensure the security features are not turned off by an unauthorized third party.

FIG. 19A shows an exemplary screenshot of the application during a sleep or suspended operational mode. As explained above, the sleep or suspended operational mode disables the transceiver of the second wireless apparatus such that there is no or little communication between the wireless apparatuses. The text status area 16A may display a “sleep” or “suspend” message and the visual status area 16B may show inactive elements.

FIG. 19B shows an exemplary screenshot of the application in a find my key operational mode. The application is in the find my phone state if the second wireless apparatus is in the locate state described above. The text status area 16A may display “finding my key . . . ” message and the visual status area 16B may show an animated icon 1901 of a second wireless apparatus with a mobile communication device (e.g. case with phone) sending signals to a first wireless apparatus (e.g. key) to indicate that the second wireless apparatus is trying to find the second wireless apparatus (e.g. key). Additionally, the user may engage the animated icon in order to mute the locate functionality of the first wireless apparatus. After the application sends this command, the application may display a second icon informing the user that the locate functionality is now muted. The user may also touch an input button on the first wireless apparatus which may send a command to end the find my key functionality of the second wireless apparatus.

FIG. 20 shows an exemplary screenshot of the application after a failed attempt to enter an armed operational mode. When attempting to enter the armed or connecting state and no first wireless apparatus is found within range, the application may display a failed message in the text status area 16A and an open lock in the visual status area 16B.

FIGS. 21A and 21B show exemplary screenshots of the application performing the mute function during an alarming operational mode. Prior to muting the system, the text status area 16A may display a “press to mute” message and the visual status area 16B may show a red flashing light that alerts a user to the alarming condition (or entered finding mode) upon sight. The visual status area 16B may further show a speaker graphic 2101A indicating to a user that the volume is on for the warning condition, alarming condition, or finding operational mode. The system may enter the mute mode in response to a user touching the graphic. Once the system is muted, the text status area 16A may display a “muted” message and the visual status area 16B may show a graphic 2101A showing a volume symbol with a line through to indicate to the user that the volume of the notification has been muted.

FIG. 22 shows an exemplary screenshot of the application during an armed operational mode when the power supply of the first wireless apparatus is low. The system may implemented power saving techniques when the power supply of a first or second wireless apparatus is low so the system may inform the user that the power is low so that the user may charge the power supply or change their behavior in response to the power changes. For example, the range setting of the system may change to a short range in order to save the power supply and ensure the longevity of the security system when in a low power state. Additionally, the cycle frequency of the poll-response mechanism may be slowed so that the battery power is saved as fewer messages will be sent in a given time frame. During a low power state, text status area 16A may not change from the ordinary status of the system at that time. However, the visual status area 16B may show a graphic 2201 showing a low battery over whichever device happens to have a low battery. For example, in FIG. 22 the first wireless apparatus is in a low power state and the low power graphic 2201 is shown on top of the first wireless apparatus. If the second wireless apparatus were low on power, a similar graphic 2201 could be shown on top of the second wireless apparatus and case.

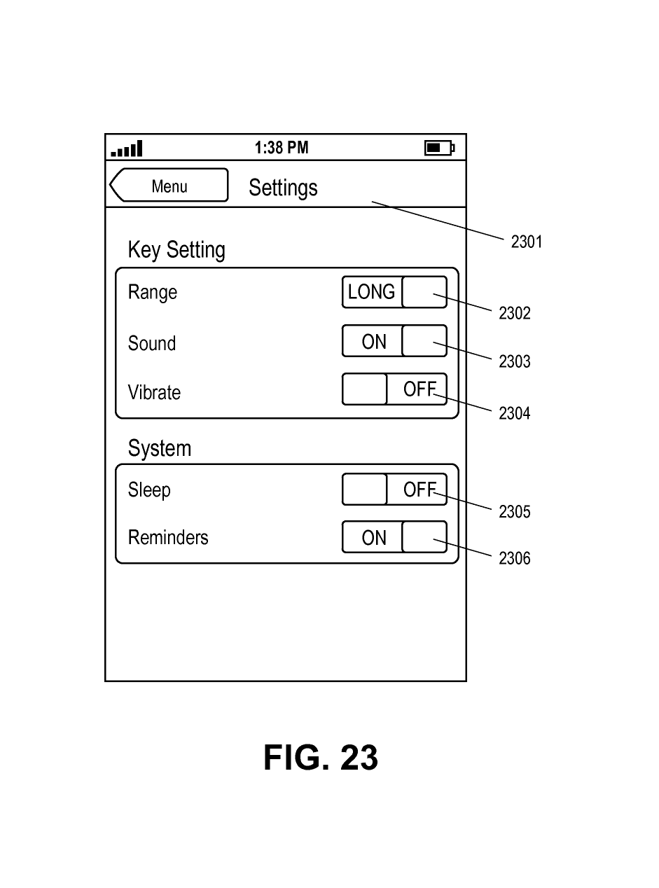

FIG. 23 shows an exemplary screenshot of the application's settings screen 2301. The settings screen 2301 may be entered at any time from any state. The settings screen 2301 consists of two sections, the first wireless apparatus (e.g. key) settings including a range 2302 setting and output settings (e.g. sound and vibrate settings of the first wireless apparatus 2303, 2304) and system settings including sleep 2305 and reminder 2306 settings.

The first wireless apparatus (e.g. key) settings section consists of settings associated with the first wireless apparatus (e.g. key) itself and changing each of these settings requires the first wireless apparatus (e.g. key) to be in range of the second wireless apparatus. When a first wireless apparatus setting is changed, a command is sent to the second wireless apparatus that a setting needs to be changed on the first wireless apparatus. In response to the command, the second wireless apparatus (e.g. case) may generate a message including data including the settings change in the next request or response message sent as part of the poll-response mechanism to the first wireless apparatus. The first wireless apparatus may receive the settings configuration change in the poll-response message, process the settings configuration, generate a confirmation message, and include the confirmation in the response or next request to the second wireless apparatus as part of the poll-response mechanism. The second wireless apparatus may wait for a success/failure indicator in the next poll-response message and may indicate to the application and subsequently the user of the application, whether the setting change was a success or failure. Accordingly, in some embodiments, in order to change any of the first wireless apparatus (e.g. key) settings, the application may send a round trip command to the second wireless apparatus, which is then sent to the first wireless apparatus, and subsequently returned to the second wireless apparatus, and a confirmation message may be provided back to the application. If the first wireless apparatus (e.g., key) is not in range, these settings may be disabled since the settings of the first wireless apparatus may not be changed if the second wireless apparatus cannot reach the first wireless apparatus or is not paired with a first wireless apparatus.

The range setting determines how far the first wireless apparatus (e.g., key) and second wireless apparatus (e.g., case) may be apart before the alarm is triggered. The user may define the separation range between the second wireless apparatus and first wireless apparatus. For example, the user can select a “long” option, where the communication range may be at a maximum of, for example, 30 feet, or a “short” option, where the communication range may be about 50% of the maximum. When the find key or find phone states are active, the communication range may have a default setting of “long.” The separation range may be set through limiting the power output of the transceiver or through any other suitable method as one of ordinary skill in the art would recognize. In this manner, the short setting could also provide battery savings as well as increased security. Additionally, the range settings may be set in any suitable manner such as, for example, five different settings beginning with a range of 10 feet and each subsequent setting extending the range by five feet. Any suitable number or method of setting the transmission range of the system may be implemented as one of ordinary skill would recognize.

The sound setting sets whether the first wireless apparatus (e.g., key) sounds when alarming. In some embodiments of the invention, the alarm tones/volumes may be configurable by the user, both on the second wireless apparatus and first wireless apparatus. There may be a set number of sound choices for different alarms. The vibrate setting determines whether the first wireless apparatus (e.g., key) vibrates when alarming.

The power settings may control whether the transceivers on the hardware are turned on and off. This setting could be implemented to include an airplane mode or could be implemented any other time when the user desires the system to power down. The power setting may turn the transceiver in the second wireless apparatus (e.g., case) on and off.

The reminder setting controls whether the application will remind the user that when the sleep or suspended setting is turned on, the application may display the following message (or message of similar affect) in dialog box: You are turning off the second wireless apparatus (e.g., case) power. Please remember to also turn off the first wireless apparatus (e.g., key) power to avoid the first wireless apparatus (e.g., key) from sounding. Similarly, when the user turns the power setting on, subject to the “Reminder” setting, the application may display the following message in dialog box, “You are turning on the second wireless apparatus (e.g. case) power. Please remember to also turn on the first wireless apparatus (e.g., key) power to re-establish the wireless connection.

The about screen button launches an information screen similar to the setting menu described above and comprises informational content for the user about the product and company. The about button may comprise a quick start guide, product registration information, legal information, and application version. The quick start guide may launch a browser or other viewer on the mobile communication device to a URL or product information screen providing information about getting started with the case (e.g. second wireless apparatus). Similar information will be available after the product registration, legal, or version buttons are touched.

### IV. Other Exemplary Embodiments

In some embodiments of the invention, it may be desirable that the first wireless apparatus can indicate its battery condition via a bi-color LED. In some embodiments of the invention, it may be desirable that this information also be passed to the second wireless apparatus for display via the application. In some embodiments of the invention, it may be desirable that the first wireless apparatus can be commanded to sound its alarm from the second wireless apparatus, to act as a lost-first wireless apparatus finder function.

In another embodiment of the invention may include pairing a first wireless apparatus with more than one second wireless apparatus. This may involve configuring a new second wireless apparatus to sniff all transmissions in the vicinity to find the first wireless apparatus, putting the first wireless apparatus in a pairing mode (perhaps by some button press sequence), acknowledging the first wireless apparatus' transmissions with a command packet instructing it to add the pairing, then exiting pairing mode. Once paired with two second wireless apparatuses a first wireless apparatus may have to transmit twice as often, making separate transmissions to each second wireless apparatus in order that the acknowledgements from the second wireless apparatuses do not collide.

In another embodiment of the invention, the system may, upon detecting the removal of all alarm conditions, cause the mobile communication device to unlock. This may be implemented as an automatic feature or as a user-initiated feature. In addition to being convenient for the user, this is an improvement to security because it could remove the need to use the first wireless apparatus (e.g., key) as a password, possibly in public, and show the first wireless apparatus to malicious third parties.

In another embodiment of the invention the system may have a “sleep mode” activated via the software interface. In the sleep mode, the radio transceivers in the first wireless apparatus and the second wireless apparatus are suspended (non-transmitting and in a low power state) but the rest of the electronics and functions (e.g. tamper detection) remain active. This allows the system to comply with rules set by some aviation authorities that govern the use of radios on aircrafts.

Specific details regarding some of the above-described aspects are provided. The specific details of the specific aspects may be combined in any suitable manner without departing from the spirit and scope of embodiments of the disclosure.

### V. Technical Advantages

Embodiments of the invention relate to a wireless security system for mobile communication devices, and provide several advantages. A first wireless apparatus carried by a user may detect if a second wireless apparatus (e.g., a case), attached to a mobile communication device, is out of range and may issue alerts and lock commands to the mobile communication device. Implementing the second wireless apparatus as a case for the mobile communication device provides convenience, security, and protection.

Advantages of embodiments of the invention includes providing a second wireless apparatus, in the form of a case, to physically protect the protected device. Since the second wireless apparatus is also electrically coupled to the mobile communication device, it can provide a tamper detection mechanism, integrate with a software interface running on the protected mobile communication device, and perform a lock on the mobile communication device sent via a first wireless apparatus (e.g., key) command.

Another advantage of embodiments of the invention is that while the first wireless apparatus and the second wireless apparatus are in range, they can be used to find each other in the case of accidental loss or misplacement of one apparatus or the other. One may issue the request to the other, via button-press on the first wireless apparatus; via application for the second wireless apparatus (e.g., case). Regardless of the arming mode of the system, the requested unit may sound the “warning chirp” for a set period of time (e.g., 15 seconds). Once the requested unit is found, this warning chirp can be silenced, much like the alarms can.

Physical tamper detection of the second wireless apparatus is another advantage provided by embodiments of the invention. The second wireless apparatus (e.g., case) may only be removed when the system is not armed. If the second wireless apparatus (e.g., case) is tampered with while the system is armed (e.g., breaking a contact sensor on the second wireless apparatus) the system may immediately enter into the alarm condition, bypass the normal warning period, and ignore the proximity of the first wireless apparatus, which would under normal circumstances negate the alarm mode. To bring the system out of this alarm state would be to re-close the second wireless apparatus (e.g., case). In some embodiments, the alarm condition may also be bypassed by completely removing the mobile communication device from contact with the second wireless apparatus if the second wireless apparatus does not have a separate power supply.

Although it may seem that removing the mobile communication device may circumvent the security system, by the time the second wireless apparatus (e.g., case) is breached, the lock command has been issued to the mobile communication device, thus the data is secure. In addition, removing the mobile communication device would shut down the second wireless apparatus circuitry but not that in the first wireless apparatus. The first wireless apparatus would react to the second wireless apparatus' apparent disappearance with the Warning/Alarm notifications. If the first wireless apparatus is in range of the second wireless apparatus (e.g., case) during a breech, the first wireless apparatus may immediately sound the alarm tone for a period of time (e.g., 30 seconds) or until muted (via button-press).

Locking of the mobile communication device also provides a novel advantage. When the system is armed, after prolonged separation of the first wireless apparatus and second wireless apparatus, the system may immediately lock the mobile communication device and then alarm. This protects the user's sensitive information on the mobile communication device from tampering, theft, or use in unauthorized activity.

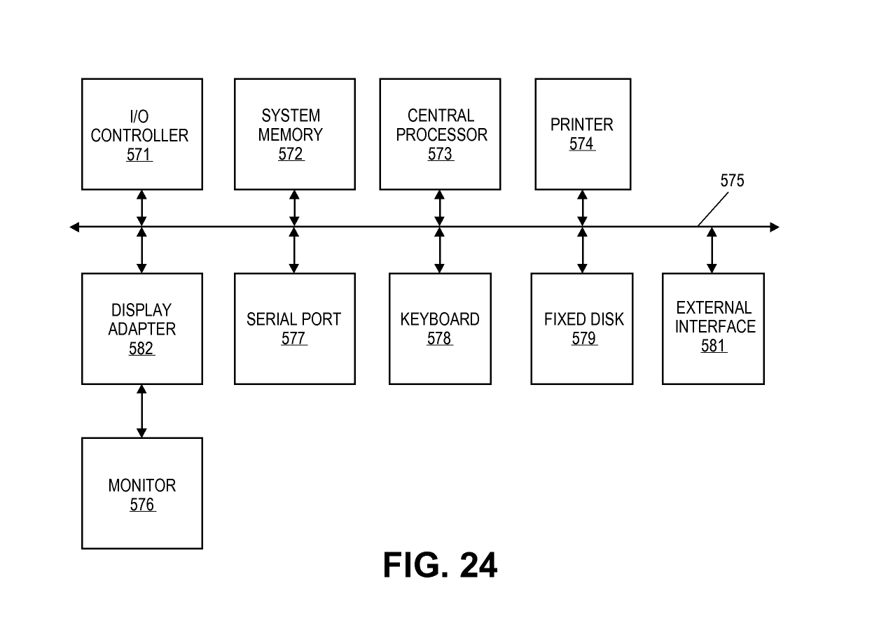

FIG. 24 shows a block diagram of subsystems that may be present in computer apparatuses that are used in system shown in FIGS. 1 and 2. The various participants and elements in the previously described figures may operate using one or more computer apparatuses to facilitate the functions described herein. Any of the elements in the figures may use any suitable number of subsystems to facilitate the functions described herein. Examples of such subsystems or components are shown in FIG. 24. The subsystems shown in FIG. 24 are interconnected via a system bus 575. Additional subsystems such as a printer 574, keyboard 578, fixed disk 579 (or other memory comprising computer readable media), monitor 576, which is coupled to display adapter 582, and others are shown. Peripherals and input/output (I/O) devices, which couple to I/O controller 571, can be connected to the computer system by any number of means known in the art, such as serial port 577. For example, serial port 577 or external interface 581 can be used to connect the computer apparatus to a wide area network such as the Internet, a mouse input device, or a scanner. The interconnection via system bus allows the central processor 573 to communicate with each subsystem and to control the execution of instructions from system memory 582 or the fixed disk 579, as well as the exchange of information between subsystems. The system memory 582 and/or the fixed disk 579 may embody a computer readable medium.

It should be understood that the present disclosure as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A security system comprising:
a first wireless apparatus for use with a mobile communication device comprising a first processor, a first antenna, and a first transceiver device electrically coupled to the first antenna and the first processor; and
a second wireless apparatus comprising a second processor, a second antenna, a second transceiver electrically coupled to the second antenna, a mobile communication device interface element, and a second computer readable medium coupled to the second processor and comprising code executable by the second processor to implement a first method, the first method comprising:
sending a wireless signal request to the first wireless apparatus;
determining whether the second wireless apparatus is within a particular distance from the first wireless apparatus; and
locking the mobile communication device from use if the second wireless apparatus is not within the particular distance from the first wireless apparatus;
wherein the second wireless apparatus is configured to removably and electrically couple to the mobile communication device through the mobile communication device interface element, and
wherein the mobile communication device comprises a third processor and a third computer readable medium coupled to the third processor and comprising code executable by the third processor to implement a second method, the second method comprising:
receiving a data input from a user; and
updating the second wireless apparatus with information corresponding to the data input.

2. The security system of claim 1, wherein the particular distance is a transmission range of the first transceiver and the second transceiver and wherein the second method further comprises synchronizing the mobile communication device and the second wireless apparatus through the mobile communication device interface element, wherein the second wireless apparatus wirelessly updates the first wireless apparatus with the information corresponding to the data input.

3. The system of claim 1, wherein the first wireless apparatus further comprises a first computer readable medium coupled to the first processor and comprising code executable by the first processor to implement a third method, the third method comprising:
determining whether the second wireless apparatus is within the particular distance from the first wireless apparatus; and
alerting a user if the second wireless apparatus is not within the particular distance from the first wireless apparatus.

4. The system of claim 1, wherein determining whether the second wireless apparatus is within a particular distance from the first wireless apparatus further comprises:
waiting a predetermined period of time to receive a response message from the first wireless apparatus; and
if no response message is received by the second wireless apparatus during the predetermined period of time, determining that the second wireless apparatus is not within the particular distance from the first wireless apparatus.

5. The system of claim 4, wherein the first method further comprises:
receiving a wireless signal response from the first wireless apparatus;
storing data contained in the wireless signal response received from the first wireless apparatus; and
communicating with the mobile communication device.

6. The system of claim 1, wherein the data input is a command for the security system to enter a disarmed state.

7. The system of claim 1, wherein the data input is a command for the security system to enter an armed state.

8. The system of claim 1, wherein the data input changes the particular distance to a close range distance, wherein the close range distance is a shorter distance than the particular distance.

9. The system of claim 1, wherein the second wireless apparatus is in the form of a case shaped to conform to a shape of the mobile communication device.

10. A method comprising:
receiving information corresponding to a data input from a mobile communication device;
updating the second wireless apparatus with information corresponding to the data input;
sending a wireless signal request to a first wireless apparatus in communication with a second wireless apparatus configured to removably and electrically couple to a mobile communication device of a user;
determining whether the first wireless apparatus is within a particular distance from the second wireless apparatus; and
locking the mobile communication device if the first wireless apparatus is not within the particular distance of the second wireless apparatus.

11. The method of claim 10, wherein determining whether the first wireless apparatus is within a particular distance from the second wireless apparatus further comprises:
waiting a predetermined period of time to receive a response message from the first wireless apparatus; and
if no response message is received by the second wireless apparatus during the predetermined period of time, determining that the second wireless apparatus is not within the particular distance from the first wireless apparatus.

12. The method of claim 10, further comprising:
determining a location of the first wireless apparatus; and
alerting the user of the location of the first wireless apparatus.

13. A method comprising:
sending a wireless signal response to a second wireless apparatus, wherein the second wireless apparatus is configured to removably and electrically couple to a mobile communication device of a user;
determining whether the second wireless apparatus is within a particular distance of the first wireless apparatus; and
alerting the user if the second wireless apparatus is not within the particular distance of the first wireless apparatus, wherein the second wireless apparatus sends a lock command to the mobile communication device if the second wireless apparatus is not within the particular distance of the first wireless apparatus.

14. The method of claim 13, further comprising:
determining a location of the second wireless apparatus; and
alerting the user of the location of the second wireless apparatus.

15. The method of claim 10, wherein the second wireless apparatus is in the form of a case shaped to conform to a shape of the mobile communication device.

16. A security system comprising:
a first wireless apparatus comprising a first processor, a first antenna, a first housing, and a first transceiver electrically coupled to the first antenna and the first processor; and
a second wireless apparatus comprising a second processor, a second antenna, a second transceiver electrically coupled to the second antenna, a second housing, a tamper switch physically coupled to the second housing and electrically coupled to the second processor, a mobile communication device interface element, and a second computer readable medium coupled to the second processor and comprising code executable by the second processor to implement a first method comprising determining if the tamper switch is triggered and locking the mobile communication device from use if the tamper switch is triggered,
wherein the second wireless apparatus is configured to removably and electrically couple to a mobile communication device through the mobile communication device interface element.

17. The system of claim 16, wherein the first wireless apparatus comprises a computer readable medium coupled to the processor and comprising code executable by the processor to implement a second method comprising:
receiving a wireless signal response from the second wireless apparatus;
determining if the wireless signal response indicates that the tamper switch is triggered; and
alerting a user if the tamper switch is triggered.

18. The system of claim 16, wherein the first method implemented by the second processor further comprises transmitting a wireless signal response to the first wireless apparatus including an indication that the tamper switch is triggered.

19. The system of claim 16, wherein the second wireless apparatus is in the form of a case shaped to conform to a shape of the mobile communication device and the tamper switch is triggered if the second wireless apparatus is opened or decoupled from the mobile communication device while the second wireless apparatus is in an armed state.

20. A method comprising:
receiving a wireless signal request from a first wireless apparatus at a second wireless apparatus, wherein the second wireless apparatus is configured to removably and electrically couple to a mobile communication device of a user, and wherein the second wireless apparatus comprises a tamper switch;
determining if the tamper switch on the second wireless apparatus is triggered; and
locking the mobile communication device from use if the tamper switch is triggered.

21. The method of claim 20, further comprising transmitting a wireless signal response to the first wireless apparatus including an indication that the tamper switch is triggered, wherein the first wireless apparatus alerts the user in response to receiving the indication that the tamper switch is triggered.
